(19) United States
(12) Patent Application Publication
(10) Pub. No.: US 2026/0200767 A1
(43) Pub. Date: Jul. 16, 2026

(54) SALT CHLORINE GENERATOR GAS REMOVAL DEVICE

(71) Applicant: Pentair Water Pool and Spa, Inc., Golden Valley, MN (US)

(72) Inventors: James Miller, Sanford, NC (US); Kenneth Koch, Apex, NC (US)

(21) Appl. No.: 19/446,221

(22) Filed: Jan. 12, 2026

Related U.S. Application Data
(60) Provisional application No. 63/743,718, filed on Jan. 10, 2025.

(51) Int. Cl. C02F 1/461; C02F 1/467; C02F 1/68; C02F 103/42

(52) U.S. Cl. CPC C02F 1/46104; C02F 1/4674; C02F 1/68; C02F 2103/42; C02F 2201/4611

(57) ABSTRACT

A salt chlorine generator is provided in the form of a housing including an inlet opening designed to receive an incoming water flow, an outlet opening designed to release an outgoing chlorinated water flow, and a chlorinator mounted in a fluid cavity defined between the inlet opening and the outlet opening. The salt chlorine generator also includes a gas removal device positioned downstream from the chlorinator and proximate to the outlet opening. The gas removal device includes a gas engagement portion in fluid communication with the fluid cavity and a stream engagement portion in fluid communication with a chlorinated water stream, the stream engagement portion having a first upstream end and a second downstream end. The first upstream end defines a first opening with a first cross-sectional area, and the second downstream end defines a second opening with a second cross-sectional area.

### CROSS-REFERENCE TO RELATED APPLICATIONS

The present application claims priority to U.S. Provisional Application Ser. No. 63/743,718, titled “SALT CHLORINE GENERATOR GAS REMOVAL DEVICE,” filed Jan. 10, 2025, the entire contents of which are hereby incorporated by reference.

### TECHNICAL FIELD

The present disclosure relates to a salt chlorine generator. More particularly, the present disclosure relates to a gas removal device for a salt chlorine generator for aquatic applications (such as a swimming pool or spa).

### BACKGROUND

Existing salt chlorine generators (SCG) include electrolytic blades that are used for chlorinating fluid passing through the blades. During operation, and when chlorine gas is being generated, the potential exists for excess gas to accumulate within the SCG. When excess gas is present, damage may be inflicted upon internal components and materials of the SCG. This damage may result in increased maintenance and a shorter operational life for the SCG.

In view of the downsides of having excess chlorine gas present within an SCG during operation, it would be advantageous to improve upon current SCG design so as to reduce and/or eliminate the presence of excess chlorine gas within an SCG.

### SUMMARY

In some aspects, a salt chlorine generator for chlorinating a fluid is provided in the form of a housing including an inlet opening designed to receive an incoming water flow, an outlet opening designed to release an outgoing chlorinated water flow, and a chlorinator mounted in a fluid cavity defined between the inlet opening and the outlet opening. The chlorinator is designed to generate chlorine gas via an electrolytic process in the fluid cavity. The salt chlorine generator also includes a gas removal device positioned downstream from the chlorinator and proximate to the outlet opening. The gas removal device includes a gas engagement portion in fluid communication with the fluid cavity and a stream engagement portion in fluid communication with a chlorinated water stream, the stream engagement portion having a first upstream end and a second downstream end. The first upstream end defines a first opening with a first cross-sectional area, and the second downstream end defines a second opening with a second cross-sectional area.

In some instances, the second cross-sectional area is less than the first cross-sectional area, such that a velocity of the outgoing chlorinated water flow increases from the first opening to the second opening. The increase in velocity draws excess chlorine gas in the fluid cavity along the gas engagement portion and into the outgoing chlorinated water flow.

In some instances, the fluid cavity is positioned or provided between the inlet opening and the outlet opening.

In some cases, the second cross-sectional area is imparted with a first value that is about 50% to about 80% less than a second value of the first cross-sectional area.

In certain instances, the stream engagement portion tapers from the first opening to the second opening.

In certain cases, the stream engagement portion is provided in the form of a truncated hollow cone that is positioned between the first opening and the second opening.

In some cases, the stream engagement portion includes one or more ridges or one or more tabs that engage the housing to prevent movement of the gas removal device along an axis defined between the inlet opening and the outlet opening.

In certain cases, the stream engagement portion includes one or more ridges or one or more tabs that engage the housing to prevent movement of the gas removal device along an axis extending between the inlet opening and the outlet opening.

In some instances, the housing includes a lip circumscribing the second cross-sectional area. In such instances, the one or more ridges or tabs abut or engage the lip to prevent movement of the gas removal device along the axis defined between the inlet opening and the outlet opening.

In some cases, the stream engagement portion includes one or more cutouts, and the housing includes one or more features, where each cutout of the one or more cutouts is designed to accept a corresponding feature of the one or more features to form a seal between the gas removal device and the housing.

In certain instances, the gas engagement portion includes a first surface projecting away from the first upstream end, and the first surface extends to a top surface of the chlorinator.

In certain cases, the first surface forms an angle of about fifteen to about sixty degrees with the first upstream end.

In some cases, the gas removal device is provided in a single-piece construction.

In some instances, the gas removal device is provided in a molded polymeric construction.

In another aspect, a gas removal device for a salt chlorine generator includes a gas engagement portion including a first surface and a stream engagement portion designed to receive a chlorinated water stream. The stream engagement portion includes a first upstream end and a second downstream end, where the first upstream end defines a first opening imparted with a first cross-sectional area and the second downstream end defines a second opening imparted with a second cross-sectional area. In addition, the first surface projects upward and away from the first upstream end. Furthermore, the second cross-sectional area is less than the first cross-sectional area.

In some instances, the gas engagement portion and the stream engagement portion are formed of a rigid polymer, said rigid polymer selected from the group including: acrylonitrile butadiene styrene (ABS), acrylonitrile styrene acrylate (ASA), polyamide (PA), polysulfone (PSF), polyethersulfone (PES), polyacrylonitrile (PAN), high-density and low-density polyethylene (PE), polypropylene (PP), and combinations thereof.

In some instances, the gas engagement portion and the stream engagement portion are formed of a rigid polymer, said rigid polymer selected from the group consisting of: acrylonitrile butadiene styrene (ABS), acrylonitrile styrene acrylate (ASA), polyamide (PA), polysulfone (PSF), polyethersulfone (PES), polyacrylonitrile (PAN), high-density and low-density polyethylene (PE), polypropylene (PP), and combinations thereof.

In some cases, the gas engagement portion further includes a second surface, a third surface and a fourth surface, where the third surface, and fourth surface are located on opposed sides of the first surface and where the second surface forms a part of or a portion of the stream engagement portion.

In certain instances, one or both of the third surface and the fourth surface extend radially from the first surface.

In certain cases, the stream engagement surface includes a hollow body defined between the first upstream end and the second downstream end.

In certain instances, the stream engagement surface includes a hollow body positioned between the first upstream end and the second downstream end.

In some cases, the hollow body is tapered between the first upstream end and the second downstream end, such that the first cross-sectional area is greater than the second cross-sectional area.

In some aspects, the first cross-sectional area and the second cross-sectional area define a circular cross-section.

In some aspects, the techniques described herein relate to a salt chlorine generator including: a housing having an inlet opening, an outlet opening and defining a fluid cavity therebetween; a chlorinator mounted in the fluid cavity between the inlet opening and the outlet opening; and a gas removal device mounted between the chlorinator and the outlet opening, the gas removal device including: a gas engagement portion including a first surface; and a stream engagement portion having a first upstream end and a second downstream end, the first upstream end defining a first opening with a first cross-sectional area, the second downstream end defining a second opening with a second cross-sectional area, where the first surface projects upward and away from the first upstream end such that the first surface engages a top of the chlorinator. In addition, the second cross-sectional area is less than the first cross-sectional area.

### DESCRIPTION OF THE DRAWINGS

FIG. 1A is an isometric view of a modular salt chlorine generator;

FIG. 1B is an exploded view of the modular salt chlorine generator of FIG. 1A;

FIG. 2A is an isometric view of the modular salt chlorine generator of FIG. 1A with a control unit removed;

FIG. 2B is a cross-sectional view taken along line 2B-2B of FIG. 2A of the modular salt chlorine generator of FIG. 1A;

FIG. 3A is an exploded view of an electrode blade carrier of the modular salt chlorine generator of FIG. 1A;

FIG. 3B is an isometric view of a first part of the electrode blade carrier of FIG. 3A;

FIG. 3C is an isometric view of a third part of the electrode blade carrier of FIG. 3A;

FIG. 3D is an isometric view of a second part of the electrode blade carrier of FIG. 3A;

FIG. 3E is an isometric view of a fourth part of the electrode blade carrier of FIG. 3A;

FIG. 3F is an isometric view of the electrode blade carrier of FIG. 3A assembled in a first position;

FIG. 3G is an isometric view of the electrode blade carrier of FIG. 3A assembled in a second position;

FIG. 3H is an isometric view of the electrode blade carrier of FIG. 3E, with an electrode blade pack therein having a plurality of electrical terminals;

FIG. 3I is an isometric view of the electrode blade carrier of FIG. 3A in a fully expanded position;

FIG. 4A is an isometric view of an alternative blade carrier that may be installed into the modular salt chlorine generator of FIG. 1A;

FIG. 4B is a partial isometric view of the electrode blade pack of FIG. 3H;

FIG. 5A is a bottom isometric view of a sensor module of the modular salt chlorine generator of FIG. 1A;

FIG. 5B is a top isometric view of the sensor module of FIG. 5A;

FIG. 5C is a partial cross-sectional view of the sensor module of FIG. 5A;

FIG. 5D is a partial cut-away view of the modular salt chlorine generator with a paddle of the sensor module of FIG. 5A in a first position;

FIG. 5E is a partial cut-away view of the modular salt chlorine generator with the paddle of the sensor module of FIG. 5A in a second (e.g., rest/home) position;

FIG. 5F is an isometric view of an electrode of a conductivity sensor of the sensor module of FIG. 5A;

FIG. 5G is an isometric view of a shroud of the sensor module of FIG. 5A for retaining at least one electrode;

FIG. 6A is an isometric view of a first part of the modular salt chlorine generator of FIG. 1A having one or more ribs therein for retaining the electrode blade carrier of FIG. 3A;

FIG. 6B is an isometric view of a second part of the modular salt chlorine generator of FIG. 1A having one or more ribs therein for retaining the blade carrier of FIG. 3A;

FIG. 6C is a cross-sectional view of the modular salt chlorine generator of FIG. 1A;

FIG. 7A is an isometric view of an alternative configuration of a modular salt chlorine generator; and

FIG. 7B is a cross-sectional view taken along line 7B-7B of FIG. 7A of the modular salt chlorine generator of FIG. 7A.

FIG. 8 is an isometric view of a salt chlorine generator;

FIG. 9 is an isometric view of a chlorinator and a gas removal device included within the salt chlorine generator of FIG. 8;

FIG. 10 is a left isometric view of the gas removal device included in the salt chlorine generator of FIG. 8;

FIG. 11 is a front view of the gas removal device of FIG. 10;

FIG. 12 is a rear view of the gas removal device of FIG. 10;

FIG. 13 is a left side view of the gas removal device of FIG. 10;

FIG. 14 is a right side view of the gas removal device of FIG. 10;

FIG. 15 is a top view of the gas removal device of FIG. 10;

FIG. 16 is a bottom view of the gas removal device of FIG. 10;

FIG. 17 is a right cross-sectional view taken along line 8-8 of FIG. 8 of a portion of the salt chlorine generator of FIG. 8;

FIG. 18 is a left cross-sectional view taken along line 8-8 of FIG. 8 of a portion of the salt chlorine generator of FIG. 8;

FIG. 19 is an isometric view of selected components of the salt chlorine generator of FIG. 8;

FIG. 20 is another isometric view of selected components of the salt chlorine generator of FIG. 8;

FIG. 21 is a front view of selected components of the salt chlorine generator of FIG. 8;

FIG. 22 is an isometric view of another salt chlorine generator;

FIG. 23 is a front view of the gas removal device of FIG. 22;

FIG. 24 is a left side view of the gas removal device of FIG. 22; and

FIG. 25 is a cross-sectional view taken along line 22-22 of FIG. 22 of a portion of the salt chlorine generator of FIG. 22.

These and other aspects and advantages of the present disclosure will become apparent to those skilled in the art after considering the following detailed description in connection with the accompanying drawings.

### DETAILED DESCRIPTION

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the disclosure. Various modifications to the illustrated embodiments will be readily apparent to those skilled in the art, and the generic principles herein may be applied to other embodiments and applications without departing from embodiments of the disclosure. Thus, embodiments of the disclosure are not intended to be limited to embodiments shown but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the disclosure. Skilled artisans will recognize that the examples provided herein have many useful alternatives and fall within the scope of embodiments of the disclosure.

As will be further explained below, the process of chlorinating a fluid with a modular salt chlorine generator (also referred to as a modular SCG) involves the production of chlorine gas through an electrolysis process. Depending upon various factors, including, for example, structural designs and fluid flow characteristics, situations may arise in which excess chlorine gas can accumulate within a housing of the modular SCG. The presence of excess chlorine gas within a housing of a modular SCG may have negative impacts on materials and components provided within the housing that are exposed to the excess chlorine gas. These negative impacts may lead to increased wear and potential component and/or material failures that may necessitate accelerated maintenance and potential replacement of the modular SCG and/or its individual components. As described below, modular SCGs that comprise designs for managing and minimizing the presence of excess chlorine gas within the housing of the modular SCG may provide long-term operational benefits. In some instances, instances of modular SCGs of the present disclosure may include gas removal devices that create favorable flow conditions, high flow velocities, and regions of higher and lower pressure within the housing of the modular SCG that facilitate the removal of excess chlorine gas within the exiting fluid flow.

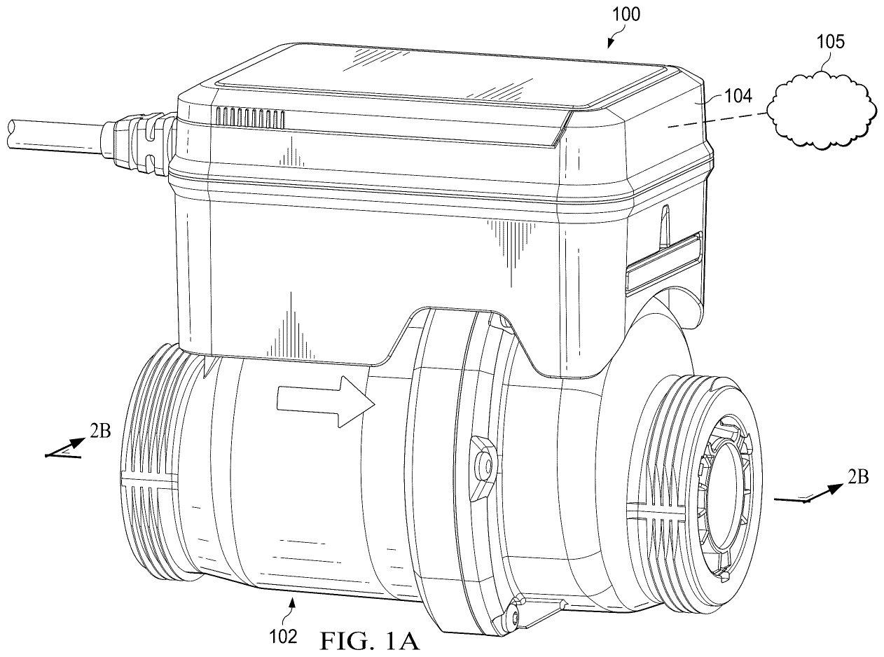

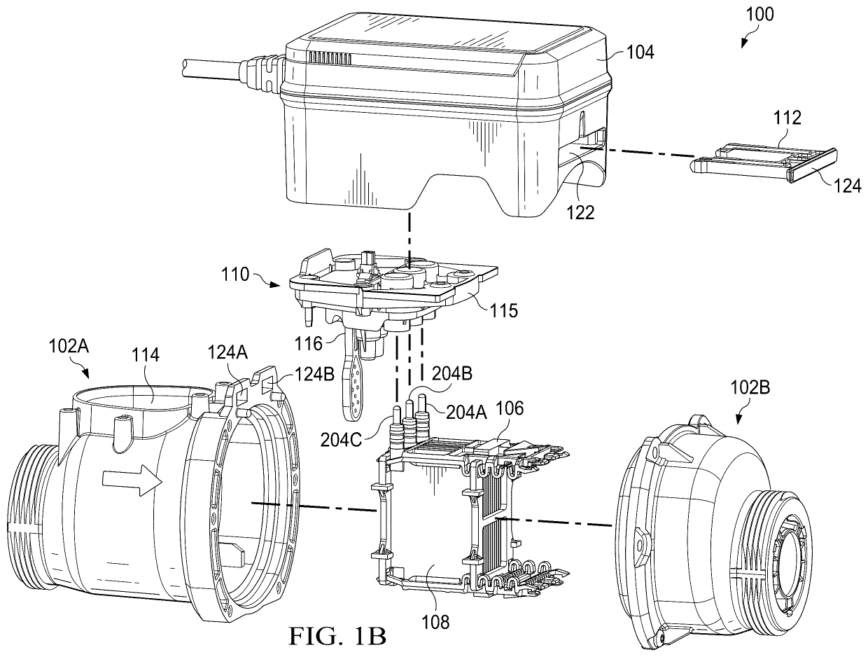

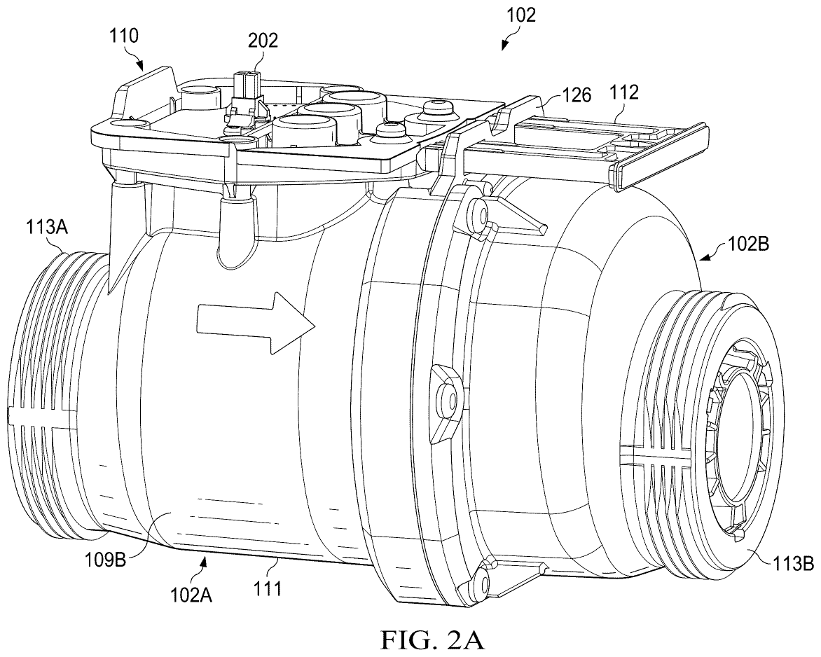

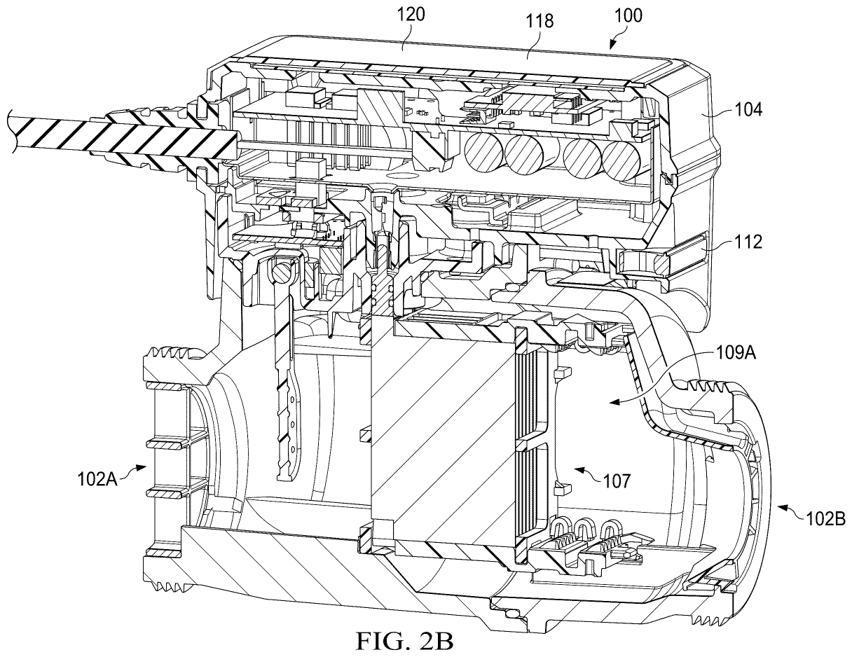

A modular salt chlorine generator 100 designed to generate chlorine is illustrated in FIGS. 1A, 1B, 2A, and 2B. The modular salt chlorine generator 100 (also referred to as a salt chlorine generator) may include a salt cell body 102 for retaining a plurality of electrode blades 108 therein, and a sensor module 110 coupled to the salt cell body 102. The plurality of electrode blades 108 may be referred to, in some instances, as an electrode blade pack. The plurality of electrode blades 108 may comprise matched sets of anode and cathode blades/plates comprising suitable materials for providing an electrical current sufficient for electrolysis whereby chlorine may be separated from a sodium molecule to provide chlorination. Also, a control unit 104 may be removably coupled to and in electronic communication with the salt cell body 102 and/or the sensor module 110. The salt chlorine generator 100 may be designed to be installed in line with an existing plumbing system (not shown), such as piping of a pool or spa system, to supply a fluid (e.g., water) to the salt chlorine generator 100. The salt chlorine generator 100 is designed to use electrolysis to produce chlorine gas or its dissolved forms, such as hypochlorous acid and sodium hypochlorite. Generally, the control unit 104 and sensor module 110 work in conjunction with the electrode blade pack 108 such that the electrical current is supplied to the individual electrode blades/plates using suitable electrical connectors, for example, electrical (e.g., blind mate) connectors 204A, 204B and 204C to facilitate electrolysis, thereby chlorinating the fluid. The general process of electrolytic chlorination in this fashion is well known in the art.

Turning to FIGS. 1, 2A, and 2B, the modular salt chlorine generator 100 may include the salt cell body 102, which may be provided in the form of a first body member 102A defining an inlet end and a second body member 102B defining an outlet end. The salt cell body 102 defines an interior cavity 107 for receiving an electrode blade carrier 106 that retains the electrode blade pack 108 designed to produce chlorine. The salt chlorine generator 100 may also include the sensor module 110 designed to measure a number of characteristics, discussed herein, of the salt chlorine generator 100 and electronically communicate the measurements to the control unit 104 and/or a network 105. Also, the salt chlorine generator 100 may include a retention or an engagement clip 112 designed to facilitate coupling the sensor module 110, the control unit 104, and/or the salt cell body 102 together.

The salt cell body 102 is provided with an interior surface 109A and an exterior surface 109B. The interior surface 109A refers to a surface of the salt cell body 102 that is internal and encloses (e.g., forms the interior cavity 107) or accommodates the electrode blade carrier 106 having the electrode blade pack 108. The exterior surface 109B refers to a surface of the salt cell body 102 that is exposed to the environment or surroundings. The exterior surface 109B may define the external aesthetics and/or the design of the salt cell body 102, for example, by illustrating a direction of flow through the salt cell body 102. A bottom side 111 of the salt cell body 102 may touch the ground or platform on which the modular salt chlorine generator 100 is installed.

The first body member 102A and/or the second body member 102B of the salt cell body 102 may be (e.g., removably) coupled together to form the interior cavity 107 therein. The interior cavity 107 is sized and shaped to retain the electrode blade pack 108 and/or the electrode blade carrier 106. In one instance, the first body member 102A is a left-side part of the salt cell body 102, and the second body member 102B is a right-side part of the salt cell body 102. The first body member 102A is coupled to the second body member 102B of the salt cell body 102 with at least one coupling mechanism, such as fasteners, nuts and bolts, adhesive, a combination thereof, and/or another suitable coupling mechanism. In one instance, each of the first body member 102A and the second body member 102B has a flange 113A/113B with an opening therein. Each flange 113A/113B is designed to be detachably connected to one or more pipes (not shown) of the existing plumbing system. Additionally, each flange 113A/113B may include threading around the outside of the flange 113A/113B to facilitate engagement with the plumbing system and to allow fluid to enter the salt chlorine generator 100 through the flange 113A/113B. For example, flange 113A of the first body member 102A acts as an inlet for the salt cell body 102, allowing the fluid to flow into the interior cavity 107, through the electrode blade pack 108, and then exit the salt cell body 102 through the flange 113B of the second body member 102B, which acts as an outlet of the salt cell body 102. Moreover, the first body member 102A may include an opening 114 sized and shaped to receive the sensor module 110.

An upper portion 115 of the sensor module 110 may be coupled to the top side of the first body member 102A of the salt cell body 102, and a lower portion 116 of the sensor module 110 may extend through the opening 114 into the first body member 102A of the salt cell body 102. Accordingly, the lower portion 116 of the sensor module 110 is positioned within the interior cavity 107 of the first body member 102A of the salt cell body 102. Continuing with FIG. 1B, one or more electrical connectors 204A, 204B, 204C facilitate an electrical connection between the control unit 104 and the sensor module 110 and the electrode blade pack 108.

The sensor module 110 is coupled to and inserted into the interior cavity 107 of the salt cell body 102 with a seal (e.g., an O-ring) therebetween. Further, a plurality of (e.g., threaded) fasteners may couple the sensor module 110 to the salt cell body 102 and compress the seal to create a watertight seal. In some instances, the plurality of threaded fasteners may be provided in the form of a stainless steel.

The sensor module 110 also is compact and modular and includes a plurality of sensors (e.g., a flow switch paddle, a temperature sensor, a conductivity sensor, and/or other electronic circuitry, discussed herein) in one place (e.g., inside the sensor module 110). When service is to be performed (e.g., repair, replacement, and/or maintenance) for the sensor module 110, the sensor module 110 may be detached from the modular salt chlorine generator 100 by removing the fasteners.

Further, a housing 118 of the control unit 104 may be removably coupled to, or integrally formed with, the top side of the salt cell body 102 such that the control unit 104 may not be in line with the salt cell body 102. The position of the control unit 104 improves access to and serviceability of the control unit 104 because the control unit 104 is separate from the electrode blade pack 108, which allows the control unit 104 and/or the electrode blade pack 108 to be serviced independently, lessening the chance of damage. In some forms, the sensor module 110 and the control unit 104 are removed from the salt cell body 102 independently from the electrode blade carrier 106 for ease of maintenance.

In one instance, the control unit 104 may include a user interface 120 on the top side of the housing 118. The user interface 120 may comprise a touchscreen, buttons, switches, and combinations thereof for allowing a user to control and/or program the operation of the salt chlorine generator 100. Further, the control unit 104 may be provided in a size and shape designed to house at least a portion of the sensor module 110 therein. Additionally, the housing 118 of the control unit 104 may include a slot 122 for the retention clip 112.

Continuing with FIG. 1A, the salt chlorine generator 100 may also include an optional network (e.g., the network 105). The control unit 104 may be communicatively coupled to the salt chlorine generator 100 to control, receive, and/or store data from the salt chlorine generator 100. For example, the control unit 104 may be in wireless communication or wired communication with a remote device, server, or database via the network 105 to directly or indirectly communicate and/or operate one or more components of the salt chlorine generator 100.

Specifically, the control unit 104 may intelligently manage and/or measure the fluid flowing through the salt chlorine generator 100. The control unit 104 may be provided in the form of a data-processing device configured to transmit and receive data from the salt chlorine generator 100. For example, the control unit 104 may receive information at a receiver (not shown). A processor (not shown) included in the control unit 104 may analyze the received data and determine instructions to be sent back to the salt chlorine generator 100. A transmitter (not shown) of the control unit 104 may send the instructions from the processor to one or more components of the salt chlorine generator 100. The control unit 104 may further include a memory (not shown). The memory may be configured to store data received from the salt chlorine generator 100. The memory may be implemented as a stand-alone memory unit and/or as part of a processor included in the control unit 104. Further, in one non-limiting embodiment, the network 105 may be coupled to the memory, which may include program instructions that are stored in the memory and executable by the processor to perform one or more of the methods described herein.

In some instances, a lookup table of predetermined values, thresholds, ranges, and other information may be stored by the control unit 104. Furthermore, the control unit 104, through communication with the network 105, may be capable of downloading lookup tables. The control unit 104 may select threshold values from the lookup tables based on a number of factors, including a determined pressure, flow rate, temperature, pH, alkalinity, and/or other parameters. In addition, the predetermined values, thresholds, ranges, and other information described with reference to any of the methods described herein may be manually implemented or otherwise input into the control unit 104 by way of the user interface 120.

In some instances, machine learning (ML), artificial intelligence (AI), or similar processes may be implemented to iteratively train the control unit 104 and improve the performance of the modular salt chlorine generator 100 based on one or more feedback parameters, characteristics, or similar information. For example, in some instances, ML/AI may be used to predict an optimal water testing interval or identify operational trends. Thus, the modular salt chlorine generator 100 may be optimized for operational efficiency and to reduce performance fluctuations in the modular salt chlorine generator 100.

The network 105 may be provided in the form of a network interface, a local network, or another communication connection and is not limited to the plurality of communication connections. One skilled in the art will recognize that a communication connection may transmit and receive data using a plurality of communication protocols, including but not limited to wired, wireless, Bluetooth, cellular, satellite, GPS, RS-485, RF, MODBUS, CAN, CANBUS, DeviceNet, ControlNet, Ethernet TCP/IP, RS-232, Universal Serial Bus (USB), Firewire, Thread, proprietary protocol(s), or other communication protocol(s) as applicable. In some embodiments, the network 105 is located proximate to one or more components of the salt chlorine generator 100. The network 105 may include the Internet, intranets, extranets, wide area networks (“WANs”), local area networks (“LANs”), wired networks, wireless networks, cloud networks, or other suitable networks, or any combination of two or more networks, Ethernet networks, and other types of networks. The network 105 may be configured to communicate directly or indirectly with the modular salt chlorine generator 100 and/or a remote user device (not shown), such as a mobile phone having an application or a display. In certain instances, the salt chlorine generator 100 may be in communication with an automation system via the network 105, such as the IntelliCenter® Pool Control System available from Pentair Pool of Apex, North Carolina, USA. In other instances, the salt chlorine generator 100 may be in communication, via the network 105, with a control system load center as described in U.S. patent application Ser. No. 18/763,233, entitled “Systems and Methods for Controlling Pool/Spa Devices,” the contents of which are incorporated by reference in its entirety herein.

Continuing with FIG. 2A, the modular salt chlorine generator 100 is shown with the control unit 104 removed for clarity. The sensor module 110 is removably coupled to the salt cell body 102 with one or more fasteners 202. A lower portion 116 of the sensor module 110 is inserted (e.g., through a top opening, such as the opening 114, in the first body member 102A) into the interior cavity 107 of the salt cell body 102 and may be sealed using a gasket, such as an O-ring. The one or more fasteners 202 may compress the gasket to create a watertight seal.

Also shown in FIGS. 1B, 2A, and 2B, the retention clip 112 also facilitates removably coupling at least one of the salt cell body 102, the control unit 104, and/or the sensor module 110 together. In one instance, the retention clip 112 is provided in a U-shape 124 having at least three sides. The retention clip 112 may be provided in the form of any polymer or plastic (e.g., Acrylonitrile Butadiene Styrene (ABS)). The retention clip 112 may snap in and out of place for insertion and removal without additional tools, and may flex, similar to a spring, during insertion and/or removal. In one instance, the retention clip 112 is inserted through the slot 122 of the control unit 104, is further inserted through a pair of eyelets 124A, 124B within a flange 126 of the salt cell body 102, and engages the sensor module 110. The retention clip 112 is designed to retain the bottom side of the control unit 104 in place on the top side of the salt cell body 102 and is further designed to maintain the electrical connections/contacts between the control unit 104 and the salt cell body 102, which in turn facilitates maintaining contact between the sensor module 110 and the control unit 104. In one instance, the retention clip 112 engages the bottom side of the control unit 104 with the external/exterior surface of the top side of the salt cell body 102.

When the retention clip 112 and/or one or more fasteners 202 are removed from at least one of the salt cell body 102, the control unit 104, and/or the sensor module 110, the control unit 104 may be removed or decoupled from the salt cell body 102, which improves the access to the control unit 104 to remove, replace, service, or repair the control unit 104 and/or components of the control unit 104.

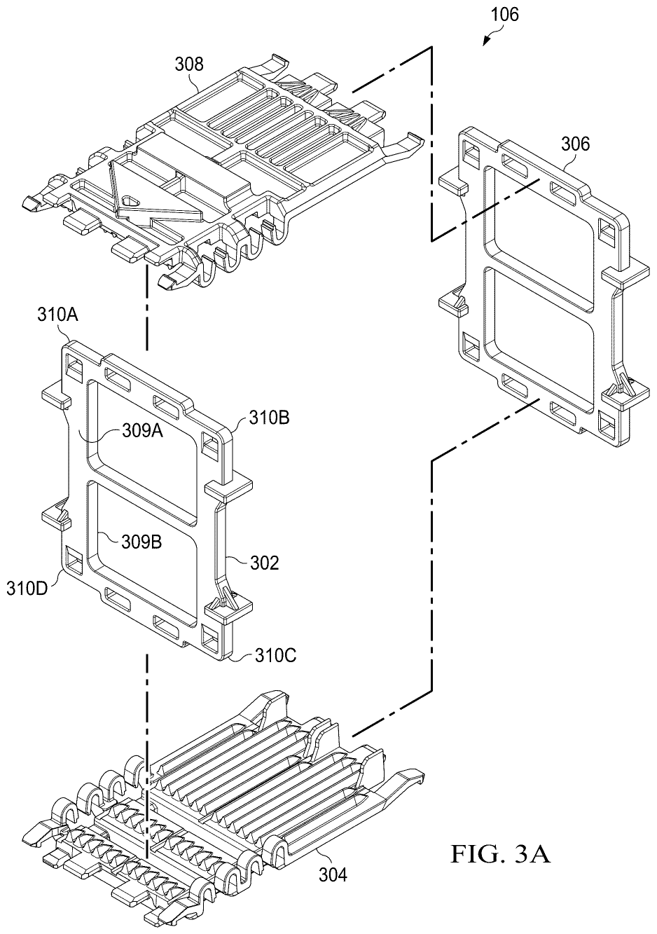

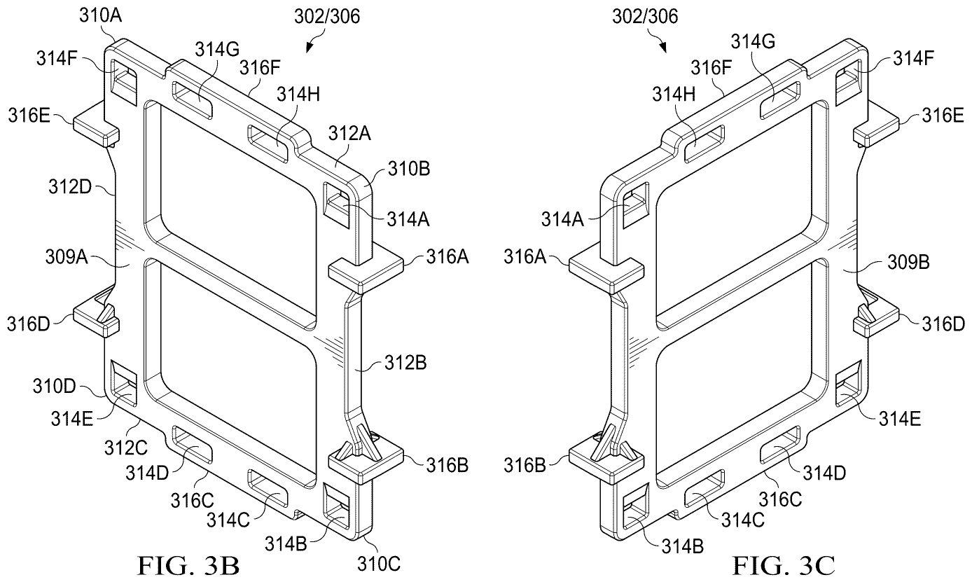

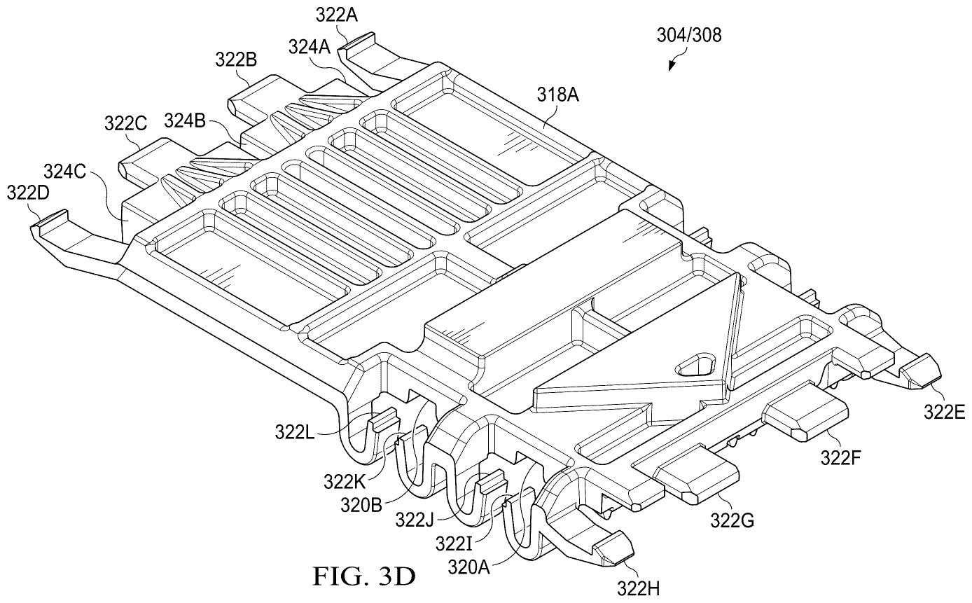

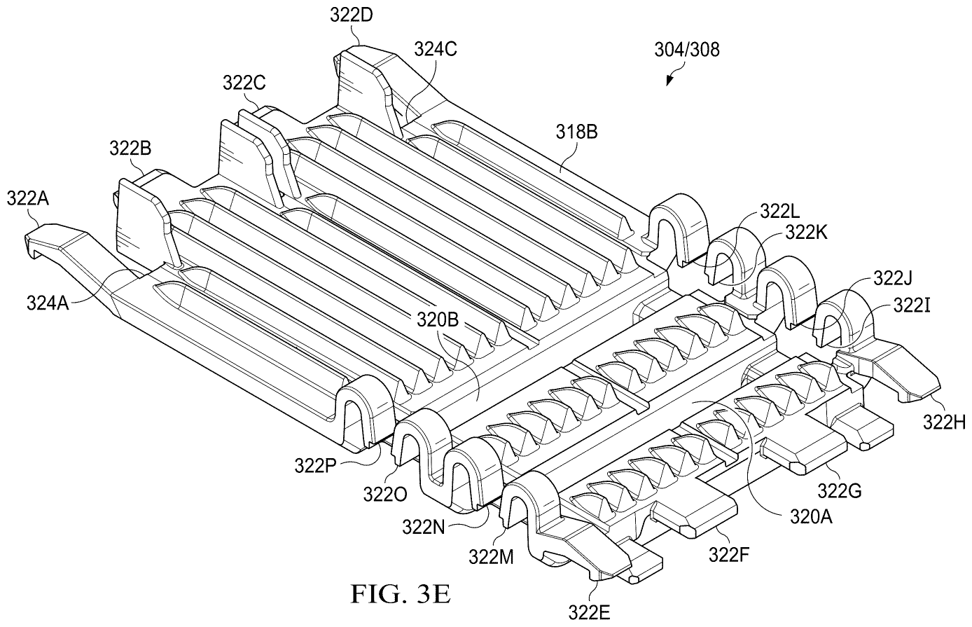

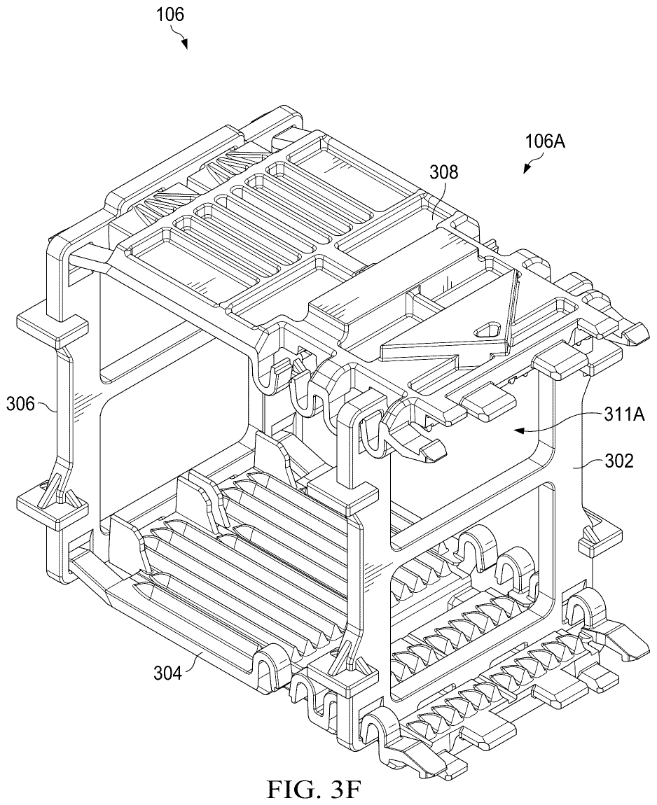

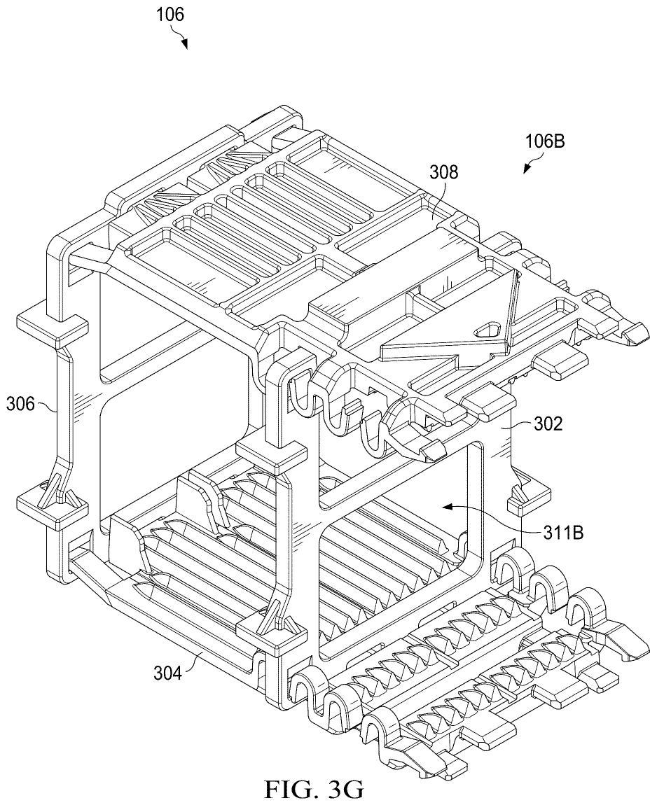

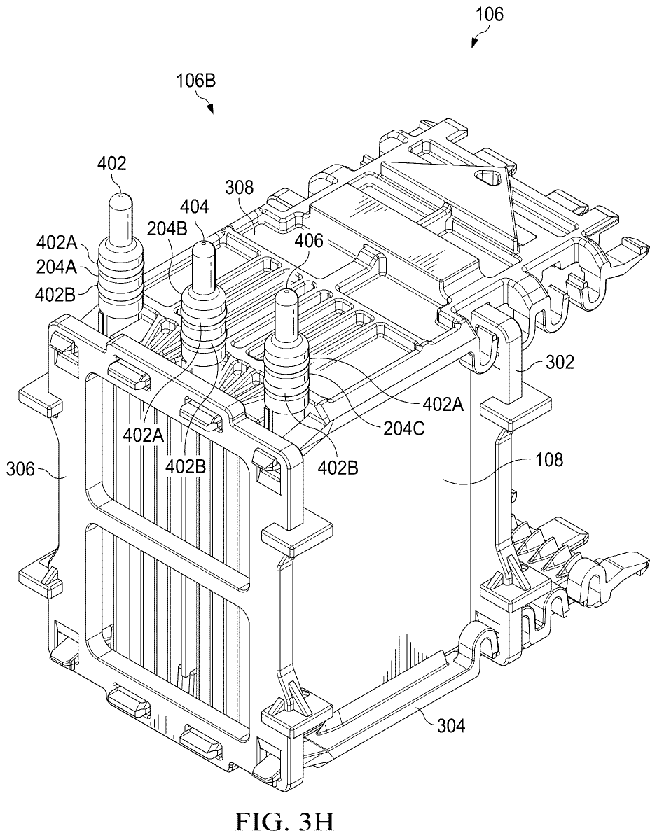

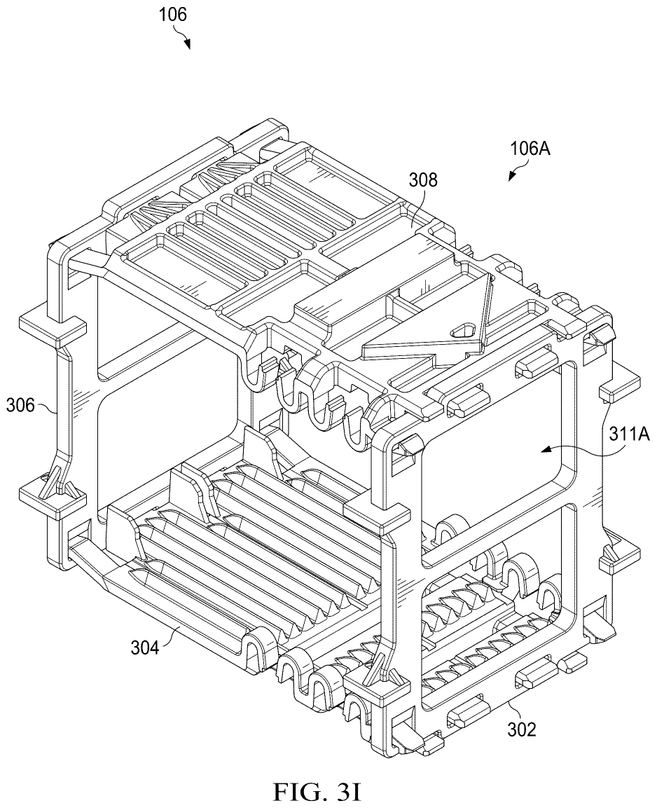

Referring now to FIG. 3A, the electrode blade carrier 106 of the modular salt chlorine generator 100 is designed to retain the electrode blade pack 108 therein. The electrode blade carrier 106 may be provided in the form of a plurality of components or sides designed to removably couple to one another. In one instance, the electrode blade carrier 106 has at least four parts or sides that form a rectangular shape when coupled together. In other instances, the electrode blade carrier 106 may form any other suitable shape for retaining the electrode blade pack 108. The plurality of components may include a first carrier member 302 and a third carrier member 304 that may be positioned at an angle (e.g., substantially perpendicular) with respect to the first carrier member 302. The plurality of components further may include a second carrier member 306 substantially parallel to and spaced a distance from the first carrier member 302, and the second carrier member 306 may be positioned at an angle (e.g., substantially perpendicular) with respect to the third carrier member 304. Additionally, the plurality of components may include a fourth carrier member 308 substantially parallel to and spaced a distance from the third carrier member 304, and the fourth carrier member 308 may be positioned at an angle (e.g., substantially perpendicular) with respect to at least one of the first carrier member 302 and the second carrier member 306. In one instance, the first carrier member 302 and the second carrier member 306 may be provided in substantially the same shape (e.g., rectangular or square) and/or substantially the same size. Similarly, in one instance, the third carrier member 304 and the fourth carrier member 308 may be provided in substantially the same shape and substantially the same size. In other instances, each carrier member 302, 304, 306, and/or 308 may be provided with the same and/or different shapes and sizes. Each carrier member 302, 304, 306, 308 may be arranged in varying positions to accommodate varying sizes of the electrode blade pack 108. In one instance, each carrier member 302, 304, 306, 308 is positioned in a first position or a second position (shown in FIGS. 3F and 3G).

In one instance, the electrode blade carrier 106 is provided in the form of an acrylonitrile butadiene styrene (ABS) material. In other instances, the electrode blade carrier 106 may be another suitable material or combination of materials. It is to be understood that the electrode blade carrier 106 may be formed of a water-resistant material.

Turning to FIGS. 3B and 3C, the first carrier member 302 and second carrier member 306 may be provided in substantially the same shape. For example, each of the first carrier member 302 and second carrier member 306 may have at least two surfaces, a first surface 309A and an opposing second surface 309B. In one instance, each of the first surface 309A and the second surface 309B has four corners 310A, 310B, 310C, 310D, and four edges or sides 312A, 312B, 312C, 312D extending between the corners 310A, 310B, 310C, 310D. In one instance, the first surface 309A may be an exterior or external or outside surface, and the second surface 309B may be an interior or internal or inside surface.

Continuing with FIGS. 3B and 3C, each of the first carrier member 302 and/or the second carrier member 306 may have a plurality of slots imparted therein, such as a first slot 314A, a second slot 314B, a third slot 314C, a fourth slot 314D, a fifth slot 314E, a sixth slot 314F, a seventh slot 314G, and an eighth slot 314H. In one instance, slots 314A, 314B, 314E, and/or 314F correspond to corners 310A, 310B, 310C, and/or 310D. Additionally, each carrier member 302 and/or 306 may include one or more tabs, such as six tabs 316A, 316B, 316C, 316D, 316E, and/or 316F. Each tab 316A, 316B, 316C, 316D, 316E, and/or 316F is designed to extend outwardly from at least one or more of the edges or the sides 312A, 312B, 312C, and/or 312D and is designed to engage other tabs (discussed herein) of other parts, such as the third carrier member 304 and/or the fourth carrier member 308.

Similarly, and turning to FIGS. 3D and 3E, each of the third carrier member 304 and/or the fourth carrier member 308 may be provided in substantially the same shape. In some forms, the third carrier member 304 and/or the fourth carrier member 308 are provided in different shapes. In one instance, the third carrier member 304 and the fourth carrier member 308 each have a first surface 318A and a second surface 318B. Both the third carrier member 304 and the fourth carrier member 308 may have two or more slots 320A and 320B and a plurality of tabs 322A, 322B, 322C, 322D, 322E, 322F, 322G, 322H, 322I, 322J, 322K, 322L, 322M, 322N, 3220, and 322P, such that the slots and the tabs are designed to facilitate coupling one or more parts (e.g., the carrier members 302, 304, 306, and/or 308) together. The third carrier member 304 and fourth carrier member 308 may also define a plurality of channels, such as a first channel 324A, a second channel 324B, and a third channel 324C.

Referring to FIGS. 3F and 3G, the second carrier member 306 may be coupled to the third carrier member 304 and the fourth carrier member 308 by aligning and coupling the corresponding tabs and slots. For instance, the second carrier member 306 is coupled to side 312C of the third carrier member 304 by inserting tabs 322A, 322B, 322C, and 322D through the slots 314E, 314D, 314C, and 314B, respectively. Similarly, the fourth carrier member 308 is coupled to side 312A of the second carrier member 306 by inserting tabs 322A, 322B, 322C, and 322D through the slots 314F, 314G, 314H, and 314A, respectively.

Turning to FIG. 3F, the electrode blade carrier 106 of the modular salt chlorine generator 100 is in a first configuration/size 106A, forming a first receiving cavity 311A. Specifically, the first carrier member 302 is positioned with respect to the third carrier member 304 and fourth carrier member 308 such that the first carrier member 302 resides in slot 320A of the third carrier member 304 and the fourth carrier member 308. The first carrier member 302 is retained in the first configuration 106A by coupling tabs 322I/322J and tabs 322M/322N of the fourth carrier member 308 with slot 314A and slot 314F of the first carrier member 302 while at the same time coupling tabs 322I/322J and tabs 322M/322N of the third carrier member 304 with the slot 314B and the slot 314E of the first carrier member 302. By coupling the associated tabs and slots of the first carrier member 302 and second carrier member 306 with tabs and slots on the third carrier member 304 and fourth carrier member 308, the electrode blade carrier 106 of the modular salt chlorine generator 100 is placed in the first configuration 106A. The salt chlorine generator 100 in the first configuration 106A (shown in FIG. 3F) is designed to accommodate a first blade pack of a first size.

In a similar manner, and as shown in FIG. 3G, the associated tabs of the first carrier member 302 and second carrier member 306 may be coupled with the tabs and slots on the third carrier member 304 and fourth carrier member 308 such that the electrode blade carrier 106 of the modular salt chlorine generator 100 is assembled to a second configuration/size 106B, so as to have a second receiving cavity 311B to accommodate a second blade pack of a second size. In the second configuration 106B, the third carrier member 304 and fourth carrier member 308 are coupled to the second carrier member 306 in the same fashion as previously described with respect to the first configuration 106A.

Indeed, the difference between the first configuration 106A and the second configuration 106B is the coupling interaction of the first carrier member 302 with the third carrier member 304 and fourth carrier member 308. Turning to FIG. 3G, the first carrier member 302 is positioned with respect to the third carrier member 304 and fourth carrier member 308 such that the first surface 312 resides in slot 320B of the third carrier member 304 and the fourth carrier member 308. The first carrier member 302 is retained in the second configuration 106B by coupling tabs 322I/322J and tabs 322M/322N of the fourth carrier member 308 with slot 314A and slot 314F of the first carrier member 302, while at the same time coupling tabs 322I/322J and tabs 322M/322N of the third carrier member 304 with the slot 314B and the slot 314E of the first carrier member 302.

By coupling the associated slots and tabs of the first carrier member 302 and second carrier member 306 with the slots and tabs of the third carrier member 304 and fourth carrier member 308, the electrode blade carrier 106 of the modular salt chlorine generator 100 is placed in the second configuration 106B. The salt chlorine generator 100 in the second configuration 106B is designed to accommodate a second blade pack of a second size. The first size, associated with the first configuration 106A, is different from the second size. In one instance, the second blade pack is smaller than the first blade pack. Also, in one instance, as shown in FIG. 3G, when the electrode blade carrier 106 is in the second position, the third and fourth carrier members 304/308 are substantially perpendicular to the first and second carrier members 302/306, and at least a portion of the third carrier member 304 and/or the fourth carrier member 308 is designed to extend outward (e.g., beyond) the first carrier member 302.

Since the electrode blade carrier 106 is arranged in at least two different configurations (i.e., the first configuration 106A and the second configuration 106B) for accommodating different sizes of the electrode blade packs 108, the first size of the first blade pack and the second size of the second blade pack may be different from each other. The size difference in the first blade pack and the second blade pack facilitates maintaining the proper amperage per square meter of exposed blade cells (or electrodes) in the flow of water. Different salt chlorine generator output values require different amperages, and different amperages require a different amount of blade cells per surface area. By using the length/size of the blade in the blade packs as the only variable, the width and connection method between all sizes of salt chlorine generators is easy to maintain. To create different salt chlorine generators with different outputs, all that needs to be done is to change the length/size of the blades in the blade pack. Indeed, and as shown in FIG. 3I, the electrode blade carrier 106 may be assembled in a third, fully expanded configuration for accommodating a third, largest size of the electrode blade pack 108.

The electrode blade carrier 106 is compact and modular. The carrier members 302, 304, 306, and/or 308 of the electrode blade carrier 106 may be removably coupled together to arrange the carrier members 302, 304, 306, and/or 308 in different, varying configurations to accommodate varying sizes of the electrode blade pack 108. In one instance, the electrode blade carrier 106 is substantially rectangular to accommodate a substantially rectangular electrode blade pack 108. Also, in one instance, the electrode blade carrier 106 may accommodate the electrode blade packs 108 of different sizes and thus, the electrode blade carrier 106 need not be replaced or changed when a different size of the electrode blade pack 108 is used.

The present disclosure provides for the electrode blade carrier 106 in at least two different positions to accommodate blade packs of two different sizes; however, it will be understood that the electrode blade carrier 106 may be positioned in any number of different positions to accommodate blade packs of any size.

Turning to FIG. 3H, the electrode blade carrier 106 is positioned in the second configuration 106B. The electrode blade carrier 106 includes a plurality of electrical terminals for the electrode blade pack 108 retained within the electrode blade carrier 106. In one instance, the electrode blade pack 108 may include a plurality of electrical terminals with each electrical terminal having at least one blind mate connector 204A, 204B, 204C (shown in FIG. 1B) to facilitate electrical communication and conductivity between the blades and at least one of the control unit 104 and/or the sensor module 110.

The plurality of electrical terminals may include a first terminal 402, a second terminal 404, and/or a third terminal 406. Each electrical terminal 402, 404, 406 may be provided in the form of a cylindrical body or another suitable shape. Further, each terminal 402, 404, 406 may be designed to extend a distance outward from the blades of the blade pack 108 such that each terminal 402, 404, 406 is substantially parallel to one another and spaced a distance apart from one another. Moreover, each terminal 402, 404, 406 is sized and designed to extend through at least one channel, for example, first channel 324A, second channel 324B, and third channel 324C of at least one of the third carrier member 304 and/or the fourth carrier member 308. In one instance, the first terminal 402 is positioned in the third channel 324C of the fourth carrier member 308, the second terminal 404 is positioned in the second channel 324B of the fourth carrier member 308, and the third terminal 406 is positioned in the first channel 324A of the fourth carrier member 308. Additionally, in one instance, each terminal 402, 404, 406 is designed to extend through at least a portion of the sensor module 110.

In one instance, each of the plurality of electrical terminals 402, 404, 406 may be provided in the form of titanium material or another suitable conductive metal. Additionally, in one instance, each of the plurality of electrical terminals 402, 404, 406 may be provided in the form of an anode electrical terminal or a cathode electrical terminal. More specifically, in one instance, the first terminal 402 and the third terminal 406 may act as an anode, and the second terminal 404 may act as a cathode. In other instances, the first terminal 402 and the third terminal 406 may act as a cathode, and the second terminal 404 may act as an anode.

Additionally, each electrical terminal 402, 404, 406 may include at least one seal, such as an O-ring, to facilitate sealing the electrical terminals 402, 404, 406 to prevent leakage of fluid from the electrode blade carrier 106 when the fluid passes through the electrode blade pack 108. In one instance, each electrical terminal 402, 404, 406 includes at least two O-rings, such as a first O-ring 402A and a second O-ring 402B spaced a distance from the first O-ring 402A.

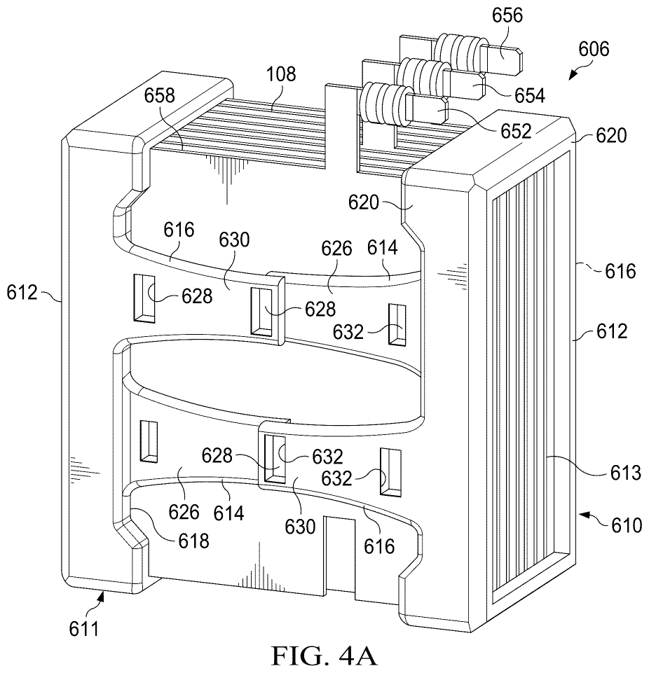

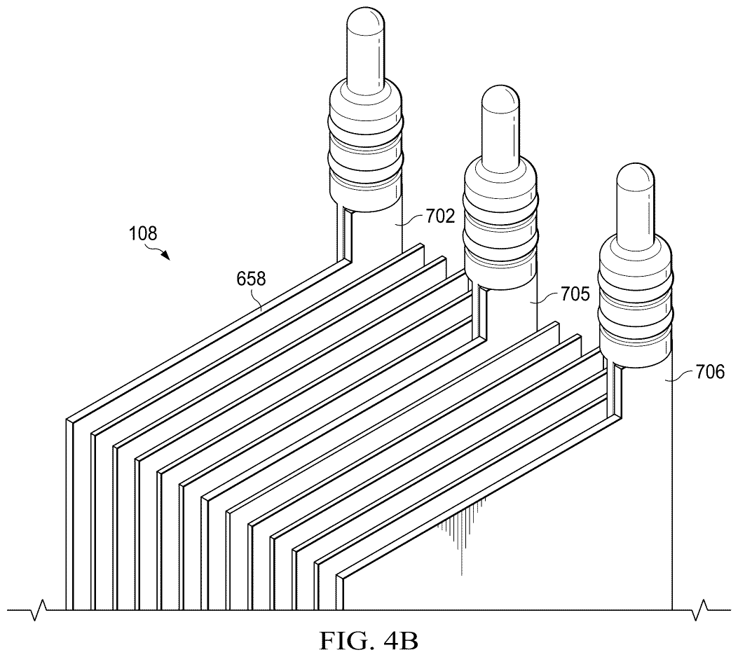

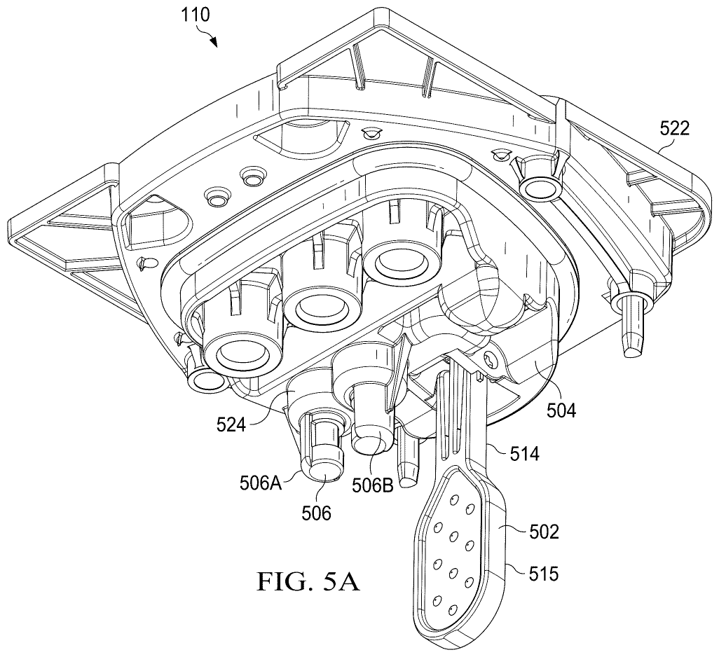

Turning now to FIG. 4A, another representative embodiment of an electrode blade carrier 606 is illustrated in which the electrode blade carrier 606 is designed to accommodate varying sizes of blade packs 108, as described herein, and is designed to protect (e.g., the edges) of the electrode blade pack 108 from damage and/or from the current flowing within the salt chlorine generator 100. The electrode blade carrier 606 has at least two carrier members 610, 611 designed to couple (e.g., snap) together to retain at least one of the electrode blade pack 108 therein. In some forms, the at least two carrier members 610, 611 are symmetrical. The carrier members 610, 611, as described herein, are substantially the same; however, it is understood that the carrier members 610, 611 may be different, such that the carrier members 610, 611 are imparted with different shapes and sizes.

In one instance, each carrier member 610, 611 has a base 612 that may be imparted with a substantially rectangular shape with an aperture 613 therein and at least two pairs of arms 614, 616 extending outwardly therefrom. The pair of arms 614 may extend from an interior side 618 of the base 612, and the pair of arms 616 may extend from an exterior (e.g., opposing) side 620 of the base 612. The pair of arms 614 may include a first arm 626 with at least one protrusion 628, and the pair of arms 616 may have a second arm 630 with at least one opening 632.

When coupling two of the carrier members 610, 611 together, the base 612 of the carrier member 610 is designed to couple to one end of the electrode blade pack 108, the base 612 of the carrier member 611 is designed to couple to a second (e.g., opposing) end of the electrode blade pack 108, and the pair of arms 614 of the carrier member 610 is designed to couple to the pair of arms 616 of the carrier member 611. More specifically, in one instance, the at least one protrusion 628 of the first arm 626 is mated with the at least one opening 632 of the second arm 630.

In other instances, the first arm 626 has at least two openings 632 therein, and the second arm 630 has at least two protrusions 628 extending outwardly therefrom. When coupling the first arm 626 of the carrier member 610 to the second arm 630 of the carrier member 611, the at least two openings 632 of the first arm 626 may align and (e.g., removably) couple with the at least two protrusions 628 of the second arm 630. Having more than one opening 632 and/or more than one protrusion 628 may facilitate adjusting the size of the electrode blade carrier 606 to accommodate different sizes of the electrode blade pack 108.

Moreover, as shown in FIG. 4A, the electrode blade pack 108 may have a plurality of terminals 652, 654, 656 extending outward from the electrode blades 658 at an angle (e.g., about 90 degrees) to facilitate communication with the control unit 104, whereby power is selectively provided to the electrode blade pack 108 to initiate the electrolysis process. Specifically, each terminal 652, 654, 656 may be positioned in the middle of the electrode blade pack 108 (e.g., a distance from each end of the electrode blade pack 108 and/or a distance from each carrier member 610, 611). Alternatively, and as shown in FIG. 4B, the electrode blade pack 108 may have a plurality of electrical terminals 702, 705, 706 to facilitate communication with the control unit 104. More specifically, the electrical terminals 702, 705, 706 may be provided with a barrel welded onto the tip. The barrel may have at least one (e.g., radial) seal (e.g., an O-ring gland) formed into the barrel. Electrical terminals 702, 705, 706 may extend outward from the electrode blades 658 of the electrode blade pack 108 so as to be essentially colinear with the electrode blades 658.

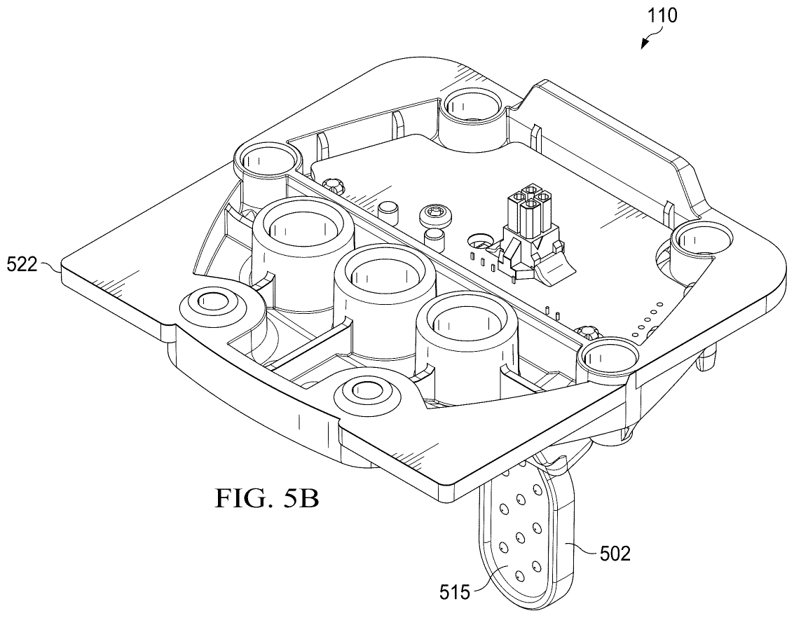

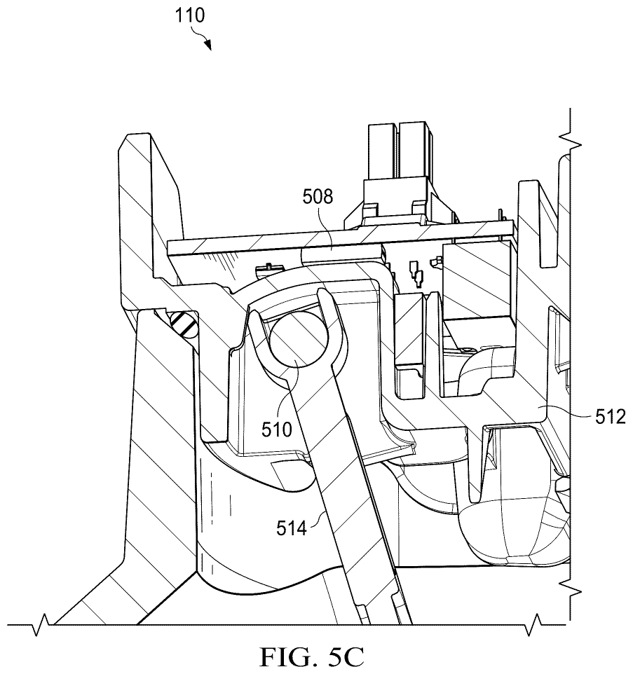

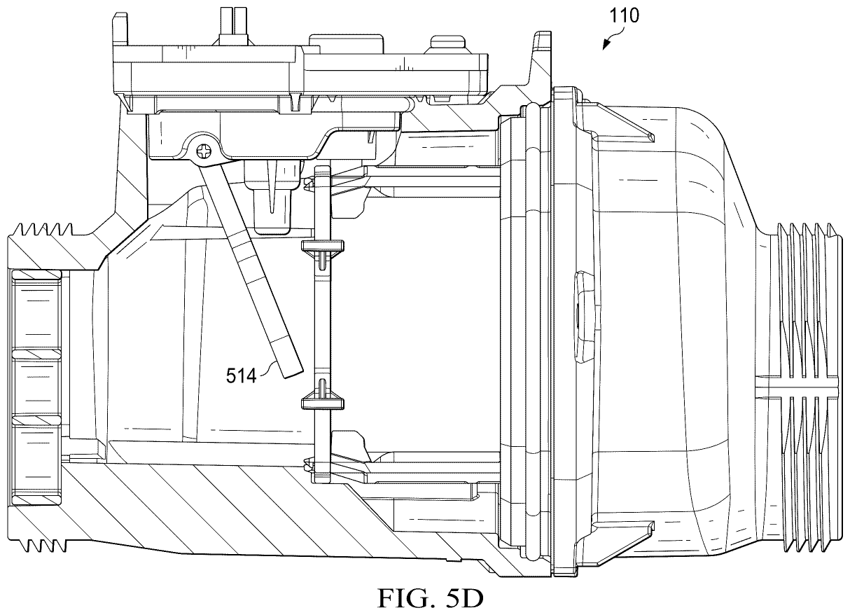

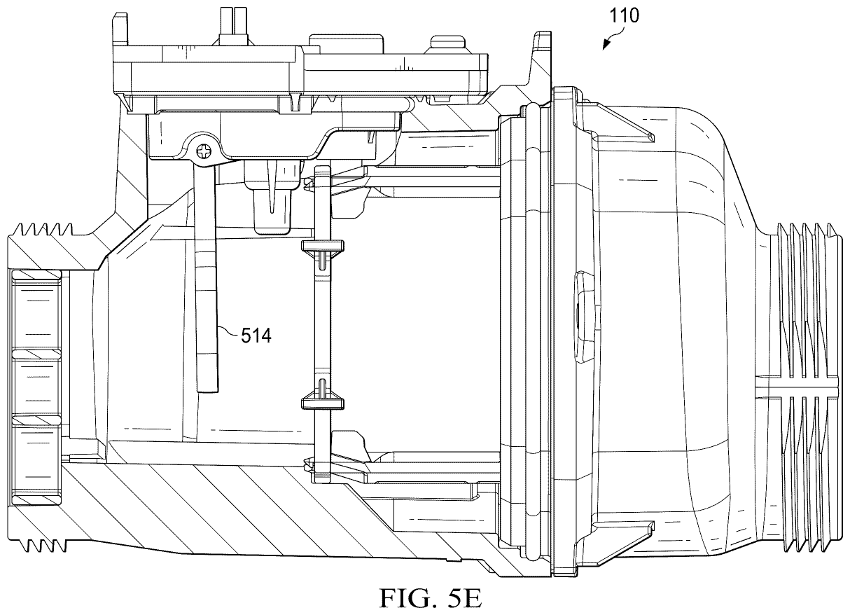

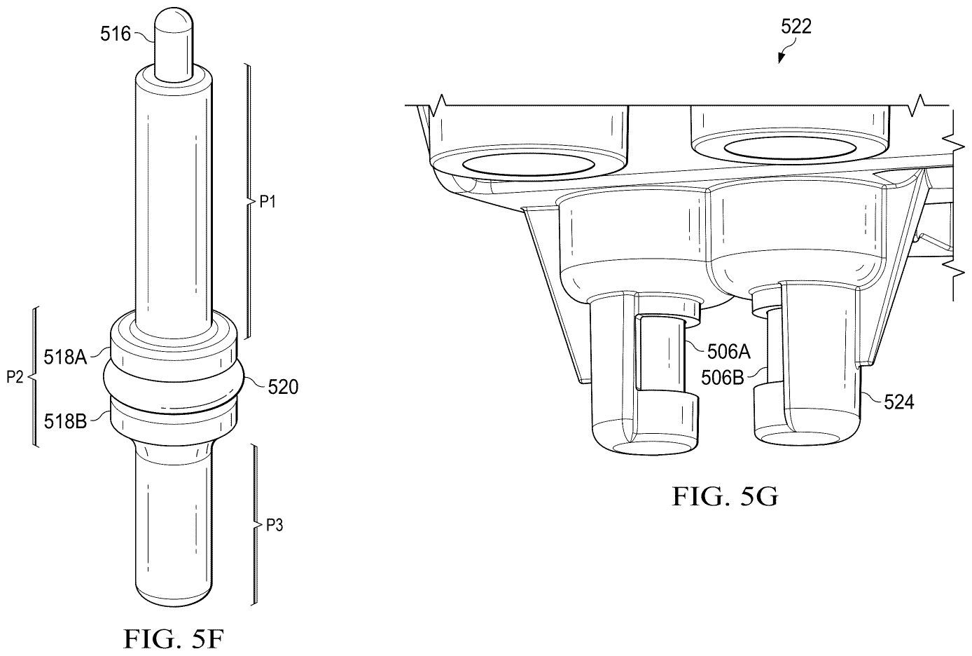

Turning to FIGS. 5A, 5B, 5C, 5D, 5E, 5F, and 5G, the sensor module 110 may be provided in the form of a housing 522 (e.g., a plastic housing) having a plurality of sensors designed to contact the water flowing through the salt chlorine generator 100 to measure various parameters, such as temperature, conductivity, and/or flow. In one instance, the plurality of sensors are retained (e.g., held in place) by the housing 522, and the sensors are separated from the electrode blades 658 of the electrode blade pack 108 so that the sensors may easily be replaced without impacting the electrode blades 658 of the electrode blade pack 108. The plurality of sensors may include a flow sensor 502 (e.g., a switch paddle), a temperature sensor 504, and/or a conductivity sensor 506. The flow sensor 502 is designed to determine whether water is present (e.g., flowing) in the salt cell body 102 of the salt chlorine generator 100 prior to creating chlorine. The temperature sensor 504 is designed to measure the temperature of the water flowing through the salt chlorine generator 100, and the conductivity sensor 506 is designed to measure the conductivity of the water flowing through the salt chlorine generator 100 (e.g., how well the fluid passing through the salt cell body 102 conducts an electrical current) and further may detect the presence of one or more chemicals, such as sodium chloride (NaCl), to assess the concentration of ions in the fluid, which may be critical in the chlorine generation process. Each sensor 502, 504, 506 may transmit collected data (e.g., measured values) to the control unit 104.

The housing 522 is provided with a shroud 524 (e.g., a pair of flanges) designed to retain at least one of the conductivity sensor 506, such that the conductivity sensor 506 may include at least two electrodes, such as a first electrode 506A and a second electrode 506B. Each electrode 506A, 506B may be provided in the form of a suitable metal, for example, titanium, gold, stainless steel, and/or any other suitable material.

In one instance, the first electrode 506A and the second electrode 506B include a cathode terminal and/or an anode terminal. Due to alternating current (AC), electrode 506A may be the anode terminal and the electrode 506B may be the cathode terminal, or the electrode 506A and the electrode 506B may switch, such that the electrode 506A may be the cathode terminal and the electrode 506B may be the anode terminal. The alternating current means that the current flows half the time from one electrode to the other electrode and the other half of the time, from the other electrode to the one electrode. The current direction switches back and forth periodically, and the anode terminal and the cathode terminal also switch when the current direction switches. Current flows from the cathode terminal to the anode terminal.

In one instance, the first electrode 506A is the cathode terminal for part (e.g., half) of the time, and the second electrode 506B is the cathode terminal for part (e.g., half) of the time. When the electrodes 506A, 506B switch, the first electrode 506A is the anode terminal for part (e.g., half) of the time, and the second electrode 506B is the anode terminal for part (e.g., half) of the time. In the water/fluid solution, the positive ions (e.g., cations) move toward the negative pole, and the negative ions move toward the positive pole, allowing the conductivity sensor 506 to measure different salinities.

As shown in FIG. 5C, the flow sensor 502 may determine whether there is flow of the fluid passing through the salt cell body 102 of the salt chlorine generator 100, as fluid is used to generate chlorine within the electrode blade pack 108 of the salt chlorine generator 100 and the lack of fluid prevents the electrode blade pack 108 from properly generating chlorine. In some instances, the flow sensor 502 may be provided in the form of a flow switch. In such instances, the flow sensor 502 may include a fulcrum (which may be provided as a plastic component) with a paddle 514 (which may be provided as a plastic component) having a magnet 510, and a reed switch 508 (e.g., a hall effect sensor) on electric circuitry of the sensor module 110. A face 515 of the paddle 514 (see FIGS. 5A, 5B) is in fluid communication with the fluid passing through the salt cell body 102. When the fluid flowing through the salt cell body 102 has enough force to move the paddle 514 (e.g., towards the right side (as shown in FIG. 5D)), the magnet 510 is moved toward the reed switch 508 and may trigger a signal to the electric circuitry of the sensor module 110. In FIG. 5D, the paddle 514 is in a tilted position, such that the magnet 510 is moved away from the reed switch 508.

As shown in FIG. 5E, when the fluid flow stops or there is no flow, the paddle 514 rotates back into its original position (e.g., home or rest position). In the home position, the paddle is in a straight or vertical position, such that the face 515 is substantially perpendicular to the housing 522. The paddle 514 may revert to the home position, because the magnet 510 in the paddle 514 is attracted to a metal 512. The attractive force is enough to bring the paddle 514 to its home position when there is less than the desired flow rate through the salt cell body 102.

Referring now to FIG. 5G, a shroud 524 of the housing 522 is designed to hold or retain at least a portion of the first electrode 506A and/or the second electrode 506B. The shroud 524 is designed to control the wetted area (e.g., a third portion P3, discussed herein and shown in FIG. 5F) of the electrode 506A, 506B, which may impact the output of the electrode 506A, 506B. A larger wetted area results in a smaller cell/probe constant, which creates a larger conductivity/salinity measurement. The shroud 524 of the housing 522 is designed to facilitate parallelism of the electrodes 506A, 506B, to substantially prevent perturbation of the reading as the current passes from one electrode to the other electrode. The housing 522 sets the center-to-center distance between the electrodes 506A, 506B, impacting the cell constant, as a larger distance between the electrodes 506A, 506B results in a larger probe constant creating a smaller conductivity/salinity measurement. In some instances, the housing 522 may be provided in the form of a plastic.

Referring now to FIG. 5F, each of the electrodes 506A, 506B of the conductivity sensor 506 has a substantially cylindrical shape and has a first portion P1, a second portion P2, and/or a third portion P3. The first portion P1 (e.g., a cylindrical pin) includes a tip 516 designed to electrically communicate with one or more electrical blind mate connectors 204A, 204B, 204C (shown in FIG. 1B) and/or the electric circuitry of the sensor module 110 and/or the control unit 104. The first portion P1 of each electrode 506A, 506B of the conductivity sensor 506 may be provided in the form of a suitable metal, for example, titanium, gold, and/or stainless steel material.

Further, the second portion P2 may include a first flange 518A and a second flange 518B spaced a distance from the first flange 518A. A seal (e.g., an O-ring) 520 may be coupled between the first flange 518A and the second flange 518B to prevent intrusion of fluid into the sensor module 110. The second portion P2 of each electrode 506A, 506B of the conductivity sensor 506 may be provided in the form of a suitable metal, for example, titanium, gold, and/or stainless steel material.

Additionally, the third portion P3 of each electrode 506A, 506B of the conductivity sensor 506 may be provided in the form of a suitable metal, for example, titanium, gold, or stainless steel material. In some instances, the third portion P3 of each electrode 506A, 506B may be coated with a titanium and/or gold metal coating, as the third portion P3 is designed to contact the fluid flowing within the salt cell body 102 (e.g., when the electrode 506A, 506B is installed into the shroud 524 of the housing 522 of the sensor module 110). In some instances, the third portion P3 of each electrode 506A, 506B is not coated with an additional metal. Providing each electrode 506A, 506B in the form of titanium and/or with titanium plating provides for a robust sensor coating that performs well in the extreme water conditions associated with pool water and the high concentrations of sodium hypochlorite (NaOCl) generated by an SCG. Titanium and/or gold plating aids in preventing corrosion. Titanium and/or gold plating also adds to the cost of the electrode, so it may be useful to minimize how much of the electrode 506A, 506B is titanium and/or gold plated. Also, minimizing the titanium and/or gold plating (e.g., on sharp corners, such as the flanges 518A, 518B) of the electrodes 506A, 506B may minimize the chance of the titanium and/or gold plating flaking off and losing adhesion with the substrate.

In particular, electroplating works by passing electricity across a metal solution, which allows the metal to adhere to the substrate in a thinly plated layer. Electroplating uses controlled electrolysis. A nickel-plated layer (also called a “woods nickel strike”) is placed on top of the stainless steel of the third portion P3, and the titanium and/or gold plating is placed on top of the nickel-plated layer (e.g., the nickel-plated layer is an intermediate layer).

The third portion P3 may be rack plated. The rack line consists of a metal frame in which the third portion P3 to be plated is suspended via racks and/or copper wire conductors. The third portion P3 to be plated is dipped into the electroplating bath for a specified time. Rack plating is used for critical parts that cannot be tumbled together as with barrel plating. Rack plating allows multiple parts to be plated at the same time, yet the parts are isolated and never come into physical contact with each other throughout the plating process. This process prevents nicks, scratches, or any other possible blemishes to the finished third portion P3.

In one instance, the thickness of the titanium and/or gold plating is greater than or equal to about 50 microinches to ensure minimal porosity and maximum plating adhesion. Further, in one instance, the titanium and/or gold plating purity is greater than about 99.7% to ensure high chemical resistance, high corrosion resistance, and/or high conductivity. When titanium and/or gold drops in purity, the titanium and/or gold plating is more susceptible to degradation in the presence of chlorine.

Minimal titanium and/or gold plating porosity ensures the nickel layer beneath the titanium and/or gold plating is not exposed to the fluid, which could impact the reading of the electrodes 506A, 506B.

Additionally, in one instance, the titanium and/or gold plating hardness is greater than about 90 Knoop hardness to lessen the wear resistance of the third portion P3 because the third portion P3 may experience high pressures and potential abrasion in the fluid in the salt cell body 102.

During operation of the conductivity sensor 506, an alternating current is applied to the two electrodes 506A, 506B. The ions in the fluid passing through the salt cell body 102 move in response to the applied voltage source from the alternating current, and that voltage is measured. The larger the conductivity of the fluid, the more the ions move, which results in a larger reading. Specifically, the voltage is measured in the electric circuitry at another point to determine the current and voltage drop across the two electrodes 506A, 506B via Ohm's law to calculate the conductance and therefore the conductivity.

The electric circuitry of the sensor module 110 and/or the control unit 104 may measure the maximum and minimum voltage across the electrodes 506A, 506B. A number of high and low readings from the peaks of the sine wave are averaged, and the difference between the average maximum voltage and the average minimum voltage is calculated to ascertain the amplitude of the sine wave (e.g., the nominal voltage from the sensor).

The voltage reading is converted into an analog-to-digital (ADC) reading. The voltage is divided by the max voltage (e.g., 5V) to get a relative value. For example, for a ten-bit microcontroller, the value is then multiplied by 2 =1024. The ADC reading is temperature-corrected based on the temperature sensor reading from the temperature sensor 504 since there is higher resistance (and thus a higher ADC reading) at higher temperatures. The ADC reading is corrected by about 2% for every 1-degree Celsius temperature change from room temperature.

Then, the ADC reading is converted to a salinity measurement using a scale factor. At first, the ADC reading is used to determine the current across the two electrodes 506A, 506B for calculating the conductance, which converts to conductivity, which further converts to salinity. Furthermore, the scale factor is proportional to a cell/probe constant of the conductivity sensor 506 and varies slightly from sensor to sensor due to slight variances in the plastic housing geometry, electrode dimensions, electric circuitry, etc. Therefore, the scale factor is adjusted during the calibration procedure by measuring the given ADC for a known salinity.

Also during operation, the two sensors (e.g., the conductivity sensor 506 and the flow sensor 502) of the sensor module 110 check for the flow of fluid (e.g., at substantially the same time) inside the salt cell body 102. Such usage of the conductivity sensor 506 and the flow sensor 502 (e.g., simultaneous) facilitates determining if there is fluid flow (e.g., or no fluid flow) inside the salt cell body 102 and increases the accuracy of the determination of fluid flow by using a reading from more than one sensor.

When the resistance of the fluid goes to infinity, the conductivity of the fluid inside the salt cell body 102 goes to 0. When the conductivity sensor 506 is in air (or vacuum) instead of the fluid (i.e., salty water), the conductivity sensor 506 measures about a 0 conductivity (or about a 0 salinity). When the conductivity sensor 506 is reading close to about 0 with some established tolerance, the conduits connected to the salt cell body 102 of the modular salt chlorine generator 100 are not receiving fluid and/or fluid is not flowing inside the salt cell body 102, which gives a no-flow indication.

The reference of a 0 reading indicates that the conductivity sensor 506 inside the salt cell body 102 is not immersed in fluid. For an instance, assuming that the tolerance is 100 parts per million (ppm). In such a case, if the salinity is <100 ppm, this indicates that there is no flow inside the salt cell body 102. It is understood that salinity of highly pure water may have an at or near 0 reading (e.g., similar to air/vacuum); however, in a pool/spa environment, the fluid is not pure deionized water with salinities<100 parts per million (ppm). For reference, tap water (without contaminants or additives such as hardness, alkalinity, etc. that are also present in the pool/spa environment) usually has a salinity reading greater than about 100 ppm. Therefore, when the conductivity sensor 506 senses the salinity less than about 100 ppm, this indicates that the conductivity sensor 506 is in the air (e.g., not in fluid flow) and creates a no flow warning.

Table 1 below provides usage of readings from the conductivity sensor 506 and the flow sensor 502 (e.g., simultaneous readings). If the flow sensor 502 senses a 0 reading and the conductivity sensor 506 senses less than 0+tolerance reading, there is no flow of fluid inside the salt cell body 102. Similarly, if the flow sensor 502 senses a 0 reading (e.g., due to the stagnant fluid inside the salt cell body 102) and the conductivity sensor 506 senses more than or equal to 0+tolerance reading, there is no flow of fluid inside the salt cell body 102. When a no-flow indication is determined, the readings from the flow sensor 502 and the conductivity sensor 506 match or align with each other.

If the flow sensor 502 senses 1 reading and the conductivity sensor 506 senses less than 0+tolerance reading, there is a possible error as the readings from the flow sensor 502 and the conductivity sensor 506 do not match or align with each other. A misalignment of the readings may indicate a problem with one or both sensors 502 and/or 506. Furthermore, if the flow sensor 502 senses a 1 reading and the conductivity sensor 506 senses more than 0+tolerance reading, there is an indication of fluid flow inside the salt cell body 102. In the flow indication, the readings from the flow sensor 502 and the conductivity sensor 506 match or align with each other.

TABLE 1

| | Conductivity Sensor | Conductivity Sensor |
|---|---|---|
| | Reading < 0 + | Reading >= 0 + |
| | tolerance | tolerance |
| Flow Switch Paddle | No Flow | No Flow |
| Reading = 0 (No flow) | | |
| Flow Switch Paddle | Sensor Error | Flow |
| Reading = 1 (Flow) | | |

Readings from the conductivity sensor 506 are communicated to the sensor module 110 and may be further communicated to the control unit 104. The user interface of the control unit 104 may display such a warning and/or notification either as warning lights with different colors or text displayed on the user interface.

Moreover, the determination of fluid flow with the flow sensor 502 and/or the conductivity sensor 506 adds reliability to the modular salt chlorine generator 100. Using the readings from the conductivity sensor 506 and the flow sensor 502 eliminates the possibility of a false positive for fluid flow inside the salt cell body 102 when there is no flow and reduces the possibility of a buildup of pressure inside the modular salt chlorine generator 100.

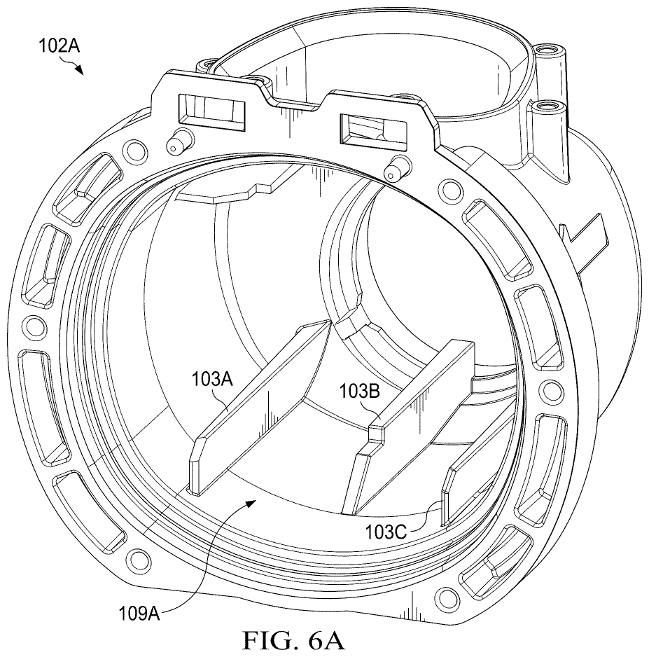

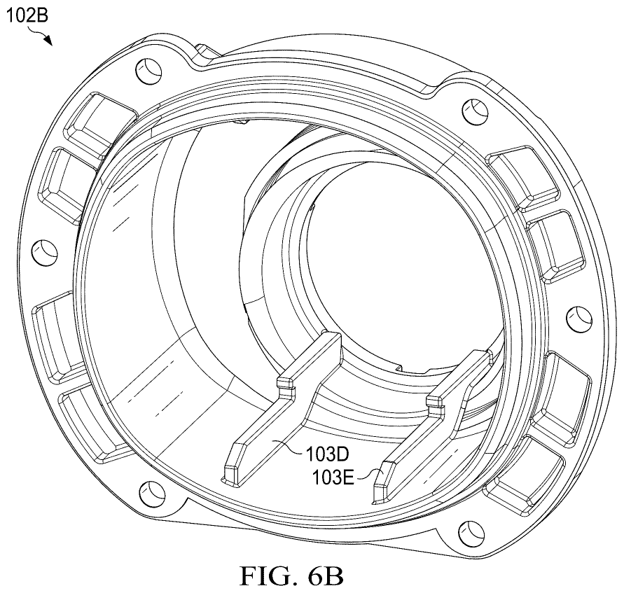

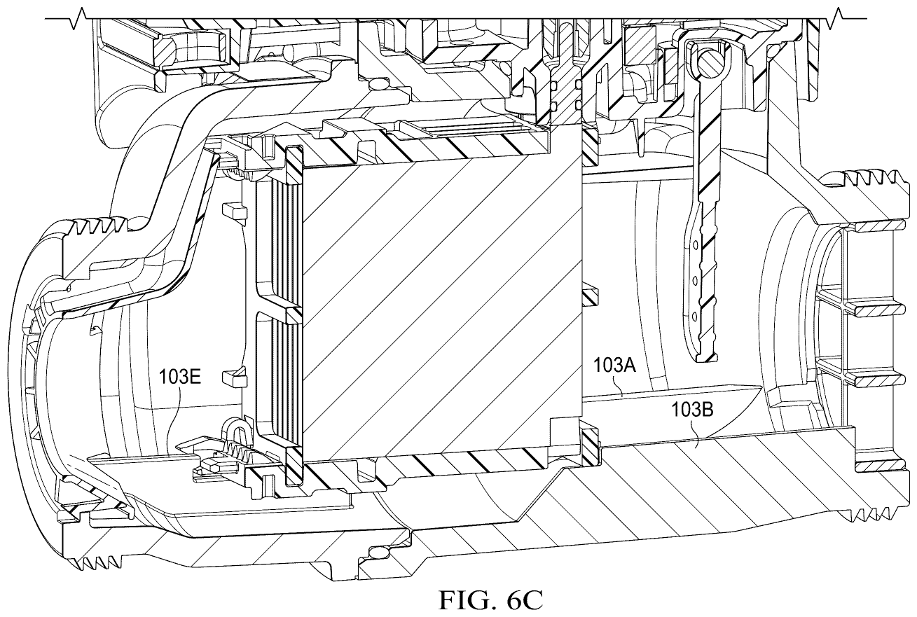

Referring to FIGS. 6A and 6B, the salt cell body 102 may include a plurality of ribs (e.g., on the interior surface 109A of the salt cell body 102) for holding the electrode blade carrier 106 of the modular salt chlorine generator 100. The ribs may be coupled to or integrally formed with the salt cell body 102 to facilitate maintaining the electrode blade carrier 106 at a substantially fixed position (e.g., constraining the electrode blade pack 108 and/or the electrode blade carrier 106 in all degrees of freedom). The first body member 102A may include one or more ribs, such as a first rib 103A, a second rib 103B, and/or a third rib 103C, and the second body member 102B may include one or more ribs, such as a fourth rib 103D and/or a fifth rib 103E. The ribs 103A, 103B, 103C, 103D, and/or 103E may be designed to engage at least a portion of the electrode blade carrier 106, such as a portion of the third carrier member 304 as illustrated in FIG. 6C.

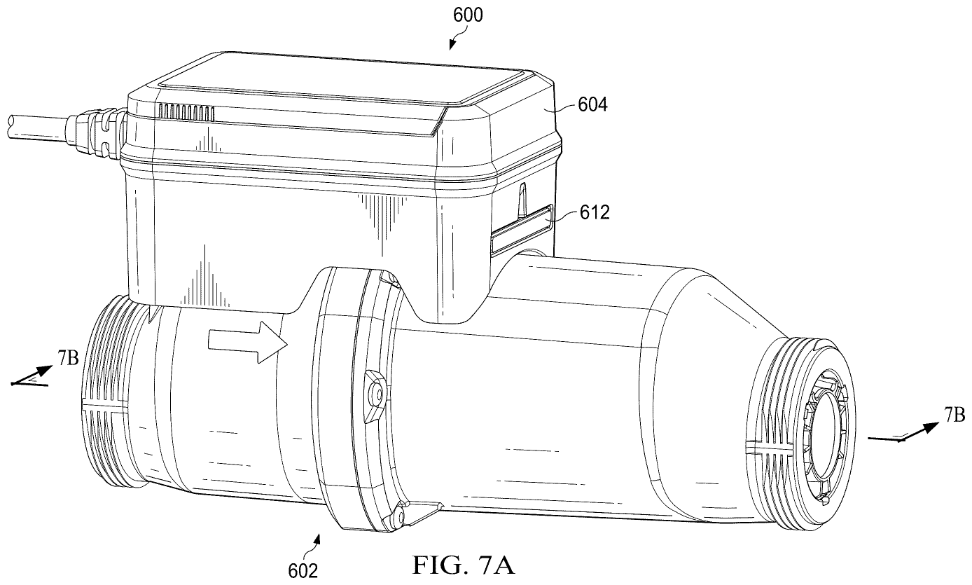

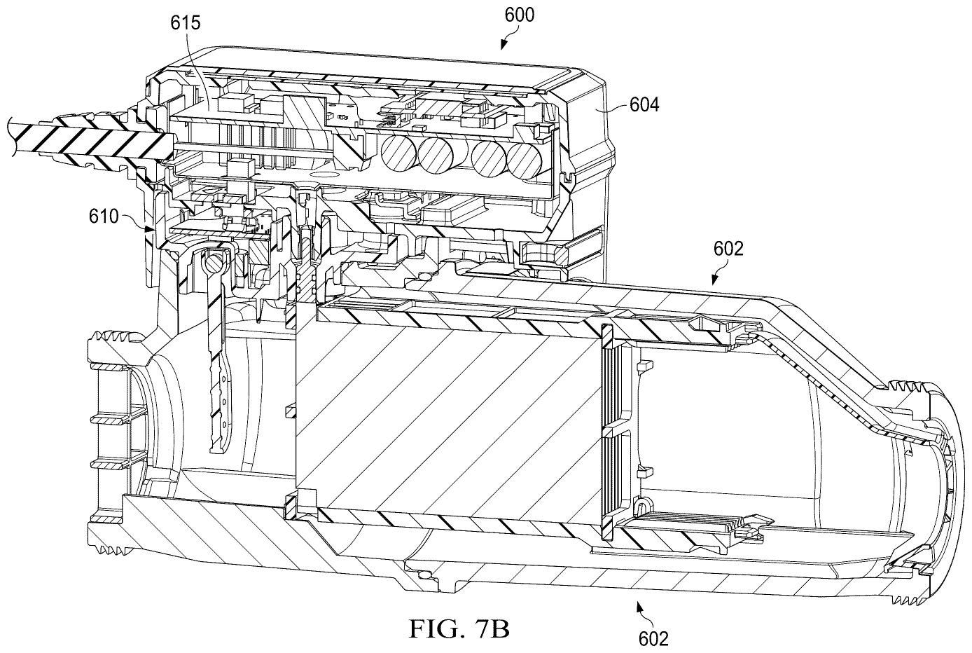

With reference to FIGS. 7A and 7B, an alternative configuration for a modular salt chlorine generator 600 is illustrated. The modular salt chlorine generator 600 may be substantially similar with respect to componentry and operation as previously described with respect to the modular salt chlorine generator 100, but with changes in construction and geometry so as to accommodate different installation environments and/or blade configurations that may be unique to certain manufacturers and suppliers. The modular salt chlorine generator 600 may include a salt cell body 602 for retaining a blade pack in a blade carrier, for example, a variation of the electrode blade carrier 106 that is dimensionally elongated and/or reduced in one or more of a width, length, or height dimension so as to accommodate specific blade pack geometries. In a manner similar to the modular salt chlorine generator 100, the modular salt chlorine generator 600 may include a sensor module 615 coupled to the salt cell body 602.

In addition, the modular salt chlorine generator 600 may include a control unit 604 that is removably coupled to and in electronic communication with the salt cell body 602 and/or the sensor module 615. Though not specifically illustrated or described, a person of ordinary skill in the art will understand that similarly described components, including, for example, salt cell body 102/602, control unit 104/604, sensor module 110/615, and engagement clip 112/612 may include similar componentry and perform similar functions but differ in size and geometry.

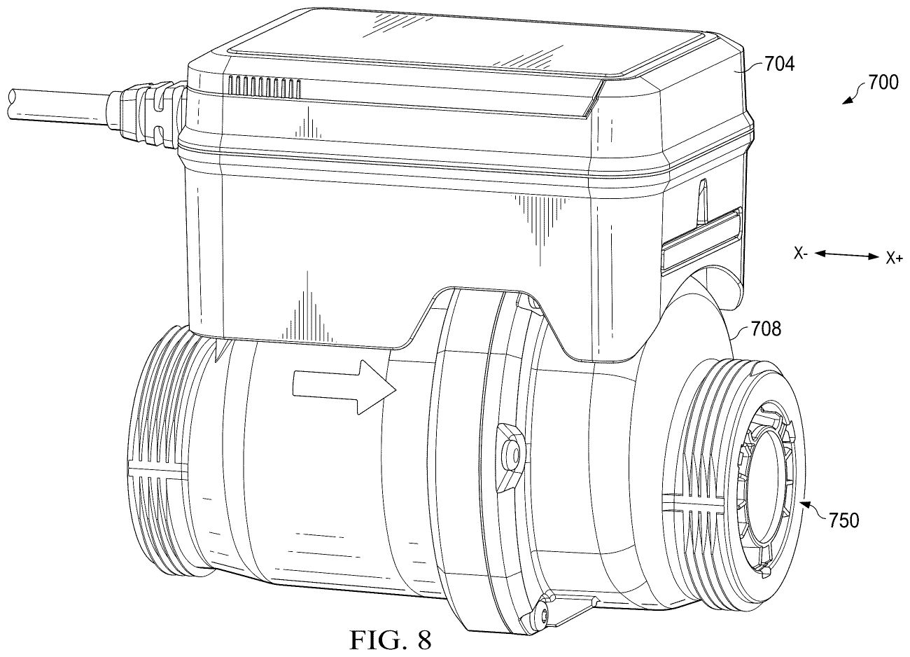

Turning now to FIG. 8, an exemplary salt chlorine generator 700 is shown. At least a portion of the salt chlorine generator 700 may be the same as the modular salt chlorine generator 100 in FIG. 1A or the modular salt chlorine generator 600 in FIG. 7A. For example, components having similar names or numbers as the components of the salt chlorine generator 100, 600 of FIGS. 1A and 7A may have substantially the same structure and function as the like-named or numbered components of the salt chlorine generator 700. The salt chlorine generator 700 may generate chlorine and/or chlorine-based compounds. In some aspects, the salt chlorine generator 700 may generate one or more of chlorine gas, hypochlorous acid, or sodium hypochlorite.

The salt chlorine generator 700 may include a control unit 704 that may include at least a portion of the control unit 104 in FIG. 1A or the control unit 604 in FIG. 7A. In some aspects, the control unit 704 may be substantially the same as the control unit 104/604 in FIGS. 1A and 7A. The salt chlorine generator 700 may further include a housing 708 that retains a chlorinator (not shown). The housing 708 may include at least a portion of the salt cell body 102/602 in FIGS. 1A and 7A. In some aspects, the housing 708 may be substantially the same as the salt cell body 102/602 in FIGS. 1A and 7A. The salt chlorine generator 700 may also include a gas removal device 750 which will be described in detail further below.

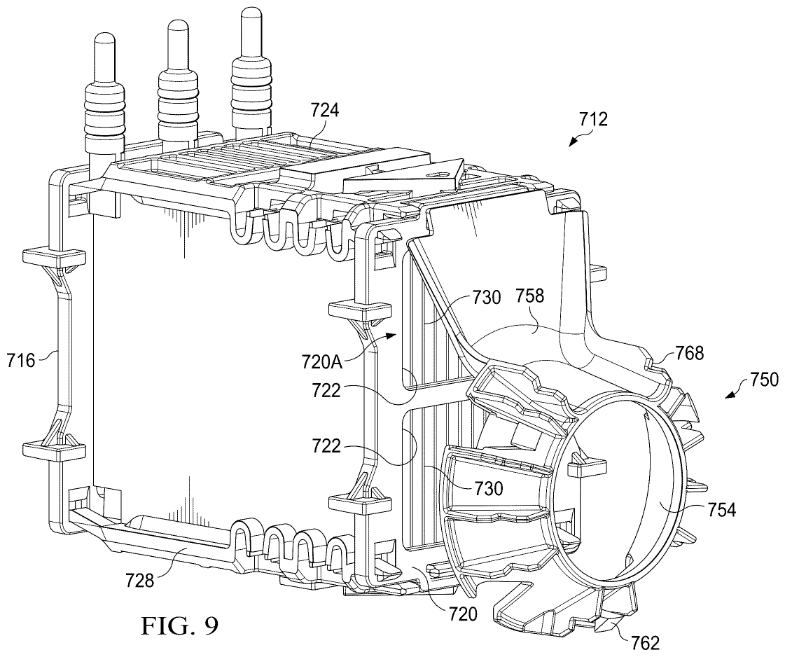

Turning now to FIG. 9, an exemplary chlorinator 712 and the gas removal device 750 of the salt chlorine generator 700 are shown. The housing 708 shown in FIG. 8 may retain the chlorinator 712 and the gas removal device 750 in the positions shown in FIG. 9. Generally, the gas removal device 750 may aid in removing certain gases generated by the chlorinator 712 (e.g., chlorine gas) by infusing the gases into a water stream. For example, the gas removal device 750 may dissolve or entrain the gases generated by the chlorinator 712 (e.g., chlorine gas) into a water stream flowing out of the chlorinator 712.

The chlorinator 712 may include a blade carrier configured to retain a plurality of blades 730. The plurality of blades 730 may form a blade pack that may be substantially the same as the electrode blade pack 108 in FIG. 1B. The plurality of blades 730 may be referred to as a blade pack. The blade carrier may include a first carrier member 716, a second carrier member 720, a third carrier member 724, and a fourth carrier member 728. The first carrier member 716, the second carrier member 720, the third carrier member 724, and the fourth carrier member 728 may be substantially the same as the first carrier member 302, the third carrier member 304, the second carrier member 306, and the fourth carrier member 308 in FIG. 3A.

The first carrier member 716 may include one or more openings configured to receive an incoming water stream. The gas removal device 750 may be positioned proximate or adjacent to the second carrier member 720. The second carrier member 720 may include a planar face 720A oriented towards the gas removal device 750. The second carrier member 720 may include one or more openings 722 configured to release a chlorinated water stream. The one or more openings 722 may define a first stream exit cross-sectional area. The size of the first stream exit cross-sectional area may be equal to the area of the one or more openings 722 provided at the planar face 720A.

The chlorinator 712 may generate the chlorinated water stream by using electrolysis to produce chlorine gas or its dissolved forms, such as hypochlorous acid and sodium hypochlorite, with a plurality of blades (e.g., electrolytic cells) that are designed to facilitate chlorinating the incoming water stream fluid.

The gas removal device 750 may include a stream engagement portion 754 and a gas engagement portion 758. The stream engagement portion 754 may be coupled to the gas engagement portion 758. In some aspects, the gas removal device 750 may be molded in a single-piece (e.g., unitary) construction. The gas removal device 750 may be formed of exemplary rigid plastic materials utilized in fluid applications, such as acrylonitrile butadiene styrene (ABS), acrylonitrile styrene acrylate (ASA), polyamide (PA), polysulfone (PSF), polyethersulfone (PES), polyacrylonitrile (PAN), high-density and low-density polyethylene (PE), polypropylene (PP), or another nonporous and nonconductive plastic, although other materials may also be used. The gas removal device 750 may also include one or more tabs 762 and/or one or more ridges 766 configured to retain the gas removal device 750 within the housing 708 shown in FIG. 8.

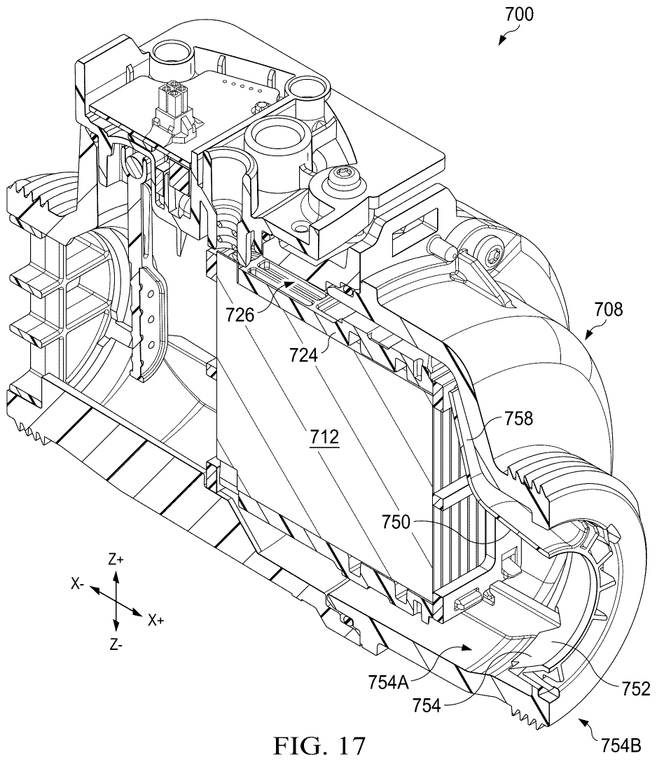

Generally, the gas removal device 750 is configured to remove excess gases, for example, chlorine gas, that may accumulate in a fluid cavity (e.g., see a fluid cavity 726 of FIG. 17). The excess gases may accumulate, for example, above the chlorinator 712 (e.g., above the third carrier member 724). The gas removal device 750 may remove the excess gases by introducing (e.g., dissolving or entraining) them into the chlorinated water stream generated by the chlorinator 712. Unchecked, the excess gases may potentially shorten the lifespan of the salt chlorine generator 700. Thus, by introducing the excess gases to the chlorinated water stream, at least a portion of any excess gases that collect above the chlorinator 712 may be removed by the chlorinated water stream, potentially prolonging the lifespan of the salt chlorine generator 700.

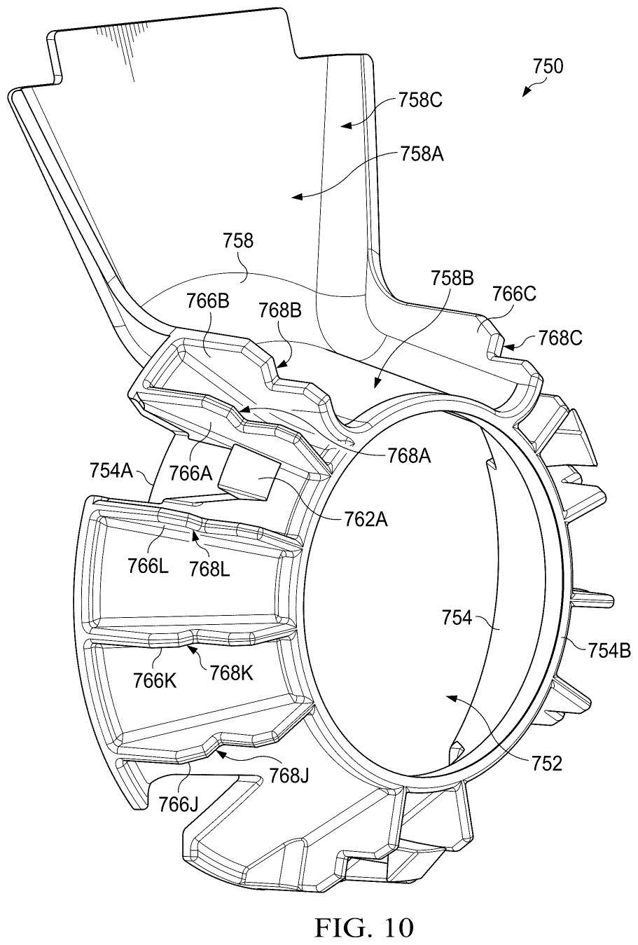

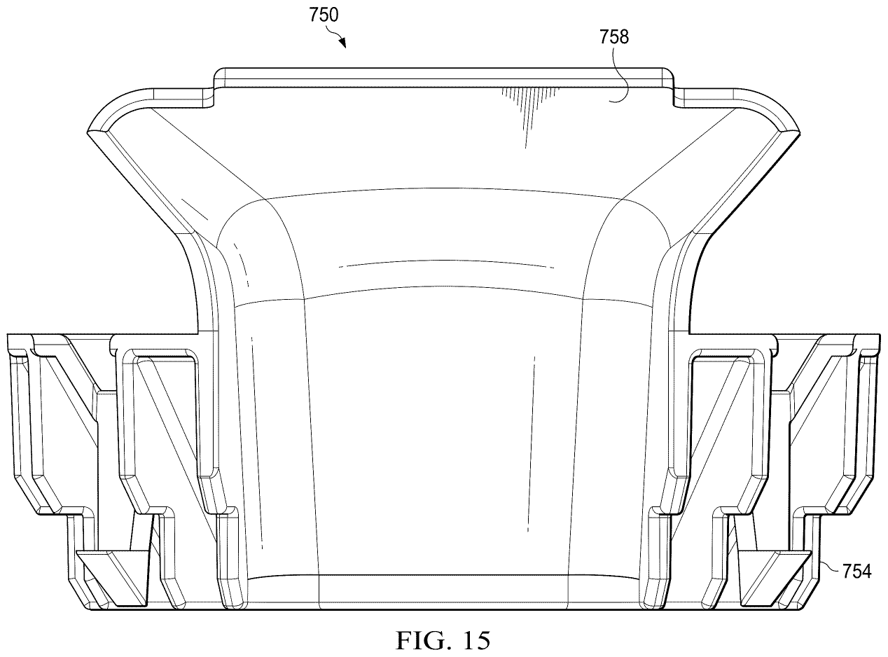

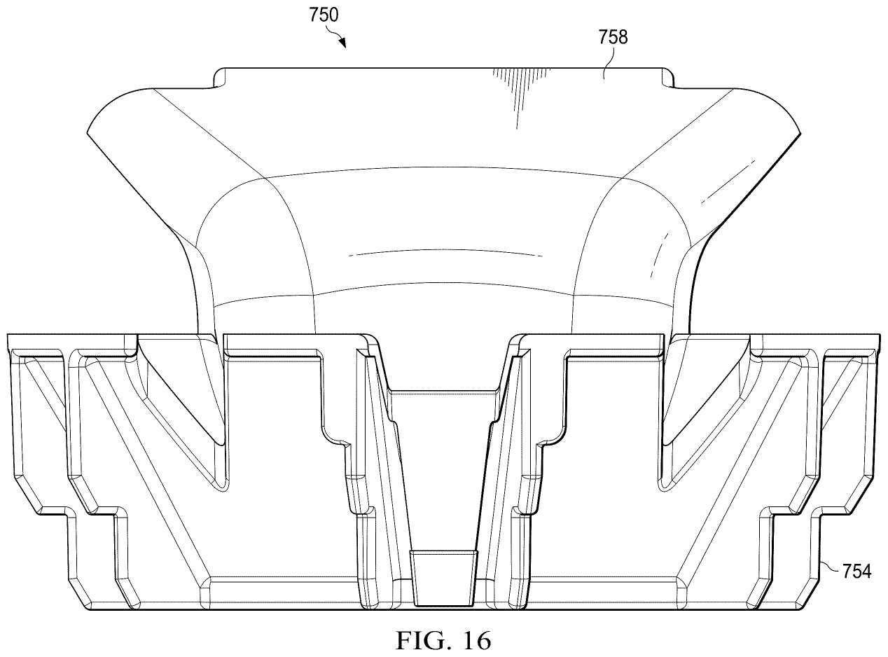

Referring now to FIGS. 10-16, the gas removal device 750 may include the stream engagement portion 754, the gas engagement portion 758, and one or more features configured to retain the gas removal device 750 in place within the housing 708 in FIG. 8. In some aspects, the stream engagement portion 754 may extend from a first or fluid inlet end 754A to a second or fluid outlet end 754B. The stream engagement portion 754 may include a hollow body defining an opening 752 fluidly connecting the first end 754A and the second end 754B, wherein the opening 752 defines a larger cross-sectional area at the first end 754A than at the second end 754B. By tapering the cross-sectional area of the opening 752 from the first end 754A to the second end 754B, the gas removal device 750 may increase a velocity of the chlorinated water stream through the opening 752. As illustrated, the opening 752 may generally define a circular cross-section, although other cross-sectional shapes (e.g., ovular, elliptical, etc.) may also be provided.

The stream engagement portion 754 may define a second end or fluid outlet cross-sectional area 752B at the second end 754B. The second end cross-sectional area 752B may be the cross-sectional area of the opening 752 at the second end 754B. The area of the second end cross-sectional area 752B may be smaller than an area of a first end cross-sectional area 752A in order to increase a velocity of the chlorinated water stream flowing through the gas removal device 750. In some aspects, both of the first end cross-sectional area 752A and the second end cross-sectional area 752B may generally define a circular cross-section, although other cross-sectional shapes (e.g., ovular, elliptical, etc.) may also be provided.

In some aspects, the area of the second end cross-sectional area 752B may be less than or equal to about seventy percent of the area of the first end cross-sectional area 752A. In some aspects, the area of the second end cross-sectional area 752B may be less than or equal to about sixty percent of the area of the first end cross-sectional area 752A. In some aspects, the area of the second end cross-sectional area 752B may be less than or equal to about fifty percent of the area of the first end cross-sectional area 752A. In some aspects, the area of the second end cross-sectional area 752B may be about fifty percent of the area of the first end cross-sectional area 752A. In some aspects, the area of the second end cross-sectional area 752B may be less than or equal to about forty percent of the area of the first end cross-sectional area 752A. In some aspects, the area of the second end cross-sectional area 752B may be less than or equal to about thirty percent of the area of the first end cross-sectional area 752A. In some aspects, the area of the second end cross-sectional area 752B may be less than or equal to about twenty percent of the area of the first end cross-sectional area 752A.

In some aspects, the area of the second end cross-sectional area 752B may be between about 20% to about 70% less than the area of the first end cross-sectional area 752A. In some aspects, the area of the second end cross-sectional area 752B may be between about 30% to about 60% less than the area of the first end cross-sectional area 752A. In some aspects, the area of the second end cross-sectional area 752B may be between about 40% to about 50% less than the area of the first end cross-sectional area 752A.

The first end 754A may face the chlorinator 712 and receive the chlorinated water stream. As the chlorinated water stream travels from the first end 754A to the second end 754B, the velocity of the chlorinated water stream increases. As the velocity of the chlorinated water stream increases, a relative pressure of the chlorinated water stream decreases. When the chlorinated water stream is released from the gas removal device 750 at the second end 754B, the relative pressure of the chlorinated water stream is less than the pressure of any gas that may have gathered above the chlorinator 712 in FIG. 17. The relatively low pressure of the chlorinated water stream may draw gas from above and/or around the chlorinator 712 down the gas engagement portion 758 and into the chlorinated water stream.

In some aspects, at least a portion of the stream engagement portion 754 may be a hollow truncated cone. In some aspects, at least a portion of the stream engagement portion 754 may be a hollow truncated cone having portions removed to help fit the gas removal device 750 within the housing 708. As will be described further below, the stream engagement portion 754 may be sized and/or shaped in order to form a seal with the housing 708 and prevent fluid (e.g., the chlorinated water stream) from partially and/or wholly bypassing the stream engagement portion 754. By preventing fluid from bypassing the stream engagement portion 754, the gas removal device 750 may increase the velocity of the chlorinated water stream as compared to if there are gaps between the stream engagement portion 754 and the housing 708 that extend from the first end 754A to the second end 754B.

The gas engagement portion 758 may be coupled to the stream engagement portion 754 and extend from a top of the chlorinator 712 towards the stream engagement portion 754. The gas engagement portion 758 may include a plurality of surfaces. The plurality of surfaces may include a first surface 758A, a second surface 758B, a third surface 758C, and a fourth surface 758D.

The first surface 758A may be coupled to each of the second surface 758B, the third surface 758C, and the fourth surface 758D. The first surface 758A may abut the second carrier member 720 near an intersection of the second carrier member 720 and the third carrier member 724. The first surface 758A may be planar or curved.

The second surface 758B may be coupled to the first surface 758A, the third surface 758C, and the fourth surface 758D. In some aspects, the second surface 758B may form a portion of the stream engagement portion 754. For example, the second surface 758B may form a portion of an outer surface of the hollow body defining the opening 752.

The third surface 758C may be coupled to the first surface 758A and the second surface 758B. The third surface 758C may extend radially away from the stream engagement portion 754. In some aspects, the third surface 758C may be a curved surface.

The fourth surface 758D may be coupled to the first surface 758A and the second surface 758B. The fourth surface 758D may extend radially away from the stream engagement portion 754. In some aspects, the fourth surface 758D may be a curved surface.

The plurality of surfaces 758A-D may be configured to facilitate the flow of gases from above the chlorinator 712 (e.g., above the third carrier member 724) to the chlorinated water stream flowing from the second end 754B of the stream engagement portion 754. More specifically, the first surface 758A, the third surface 758C, and the fourth surface 758D may be shaped to funnel gases from above the chlorinator 712 towards the second surface 758B and out towards the second end 754B of the stream engagement portion 754.

It is to be appreciated that, in some instances, the first surface 758A, the second surface 758B, the third surface 758C, and the fourth surface 758D may be unitary (e.g., provided in one piece).

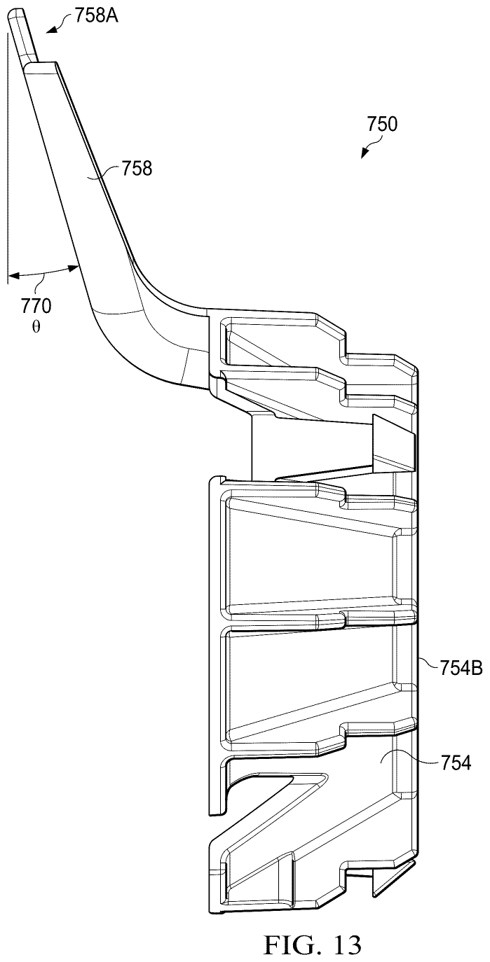

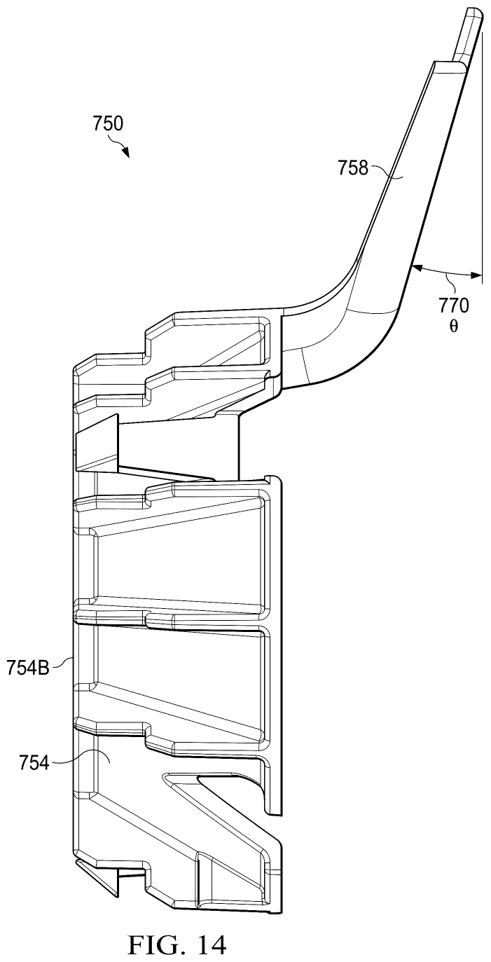

Referring to FIGS. 13 and 14, the gas engagement portion 758 may extend away from the stream engagement portion 754 at a predetermined angle 770. More specifically, a portion of the gas engagement portion 758 (e.g., the first surface 758A in FIG. 10) may form the angle 770 with the first stream exit cross-sectional area 752A. The angle 770 may be about fifteen to about sixty degrees, although the angle 770 may also be imparted with smaller or greater values. For example, the angle 770 may be imparted with a value of at least about fifteen degrees, or at least about twenty degrees, or at least about twenty-five degrees, or at least about thirty degrees, or at least about thirty-five degrees, or at least about forty degrees, or at least about forty-five degrees, or at least about fifty degrees, or at least about fifty-five degrees, or at least about sixty degrees, or no more than about sixty degrees. In some aspects, the angle 770 may be about thirty degrees. The angle 770 may be selected to fluidly couple the gas engagement portion 758 to the area above the chlorinator 712 in FIG. 17. Furthermore, based on the design of the housing 708 in FIG. 8, the angle 770 may be selected to allow the gas engagement portion 758 to extend from the top of the chlorinator 712 to the stream engagement portion 754, which may be in a predetermined location within the housing 708 based on one or more features designed to retain the gas removal device 750 in place within the housing 708, as will be described below.

Referring again to FIGS. 10-16, the gas removal device 750 may include one or more features configured to retain the gas removal device 750 in place within the housing 708 in FIG. 8. The one or more features may include the one or more tabs 762 and/or the one or more ridges 766. In some aspects, the one or more tabs 762 may include a plurality of tabs including a first tab 762A, a second tab 762B, and a third tab 762C. In some aspects, the one or more ridges 766 may include a plurality of ridges including a first ridge 766A, a second ridge 766B, a third ridge 766C, a fourth ridge 766D, a fifth ridge 766E, a sixth ridge 766F, a seventh ridge 766G, an eighth ridge 766H, a ninth ridge 766I, a tenth ridge 766J, an eleventh ridge 766K, and a twelfth ridge 766L. It is to be appreciated that additional or fewer of the one or more tabs 762 and the one or more ridges 766 may be provided in alternative implementations of the gas removal device 750.

The plurality of ridges 766A-L may be coupled to and extend radially from the hollow body of the stream engagement portion 754. Each ridge of the plurality of ridges 766A-L may include or be provided with an engagement surface of engagement surfaces 768A-L. At least a portion of each engagement surface of the engagement surfaces 768A-L may be approximately parallel with the second end cross-sectional area 752B. Each of the engagement surfaces 768A-L may be configured to abut and/or engage a portion of the housing 708 and to help prevent the gas removal device 750 from moving in the positive x-direction along an X-X axis, as shown in FIG. 8. In some aspects, each engagement surface of the engagement surfaces 768A-L may be configured to abut and/or engage a portion of the housing 708 and to help prevent the gas removal device 750 from moving along an axis perpendicular to the first stream exit cross-sectional area 752A.

Each of the plurality of tabs 762A-C may include an engagement surface of the engagement surfaces 764A-C. At least a portion of each engagement surface of the engagement surfaces 764A-C may be approximately parallel with the second stream exit cross-sectional area 752B. Each engagement surface of the engagement surfaces 764 A-C may be configured to abut and/or engage a portion of the housing 708 and help prevent the gas removal device 750 from moving in a negative x-direction along the X-X axis shown in FIG. 8. Each of the plurality of tabs 762A-C may be configured to flex and allow installation (e.g., during manufacturing) of the engagement surfaces 764 A-C at predetermined positions near the housing 708.

In another aspect, the gas removal device 750 may include additional or fewer tabs 762A-C, engagement surfaces 764A-C, and ridges 766A-L than described herein. It is to be understood that suitable numbers of tabs, ridges, and/or engagement surfaces may be provided to help prevent movement of the gas removal device 750 along the X-X axis of FIG. 8.

Referring now to FIG. 17, the salt chlorine generator 700 may include a fluid cavity 726 arranged, positioned, or provided between the chlorinator 712 and the housing 708. More specifically, the fluid cavity 726 may be arranged, positioned, or provided between a top side of the chlorinator 712 (e.g., above the third carrier member 724) and below a portion of the housing 708 located above the chlorinator 712. In other words, the fluid cavity 726 may extend from a top side of the chlorinator 712 towards the housing 708 in a positive z-direction along the Z-Z axis shown in FIG. 17. Gases generated by the chlorinator 712, such as chlorine gas, may accumulate in the fluid cavity 726. The gas removal device 750 may be in fluid communication with the fluid cavity 726. More specifically, the gas engagement portion 758 of the gas removal device 750 may be in fluid communication with the fluid cavity 726. The gas removal device 750 may draw the one or more gases that may have accumulated in the fluid cavity 726 downwardly and into the chlorinated water stream, as described above. For example, the gas removal device 750 may draw gas from the fluid cavity 726 down the gas engagement portion 758 towards the second end 754B and mix the gas with the chlorinated water stream released by the stream engagement portion at the second end 754B.

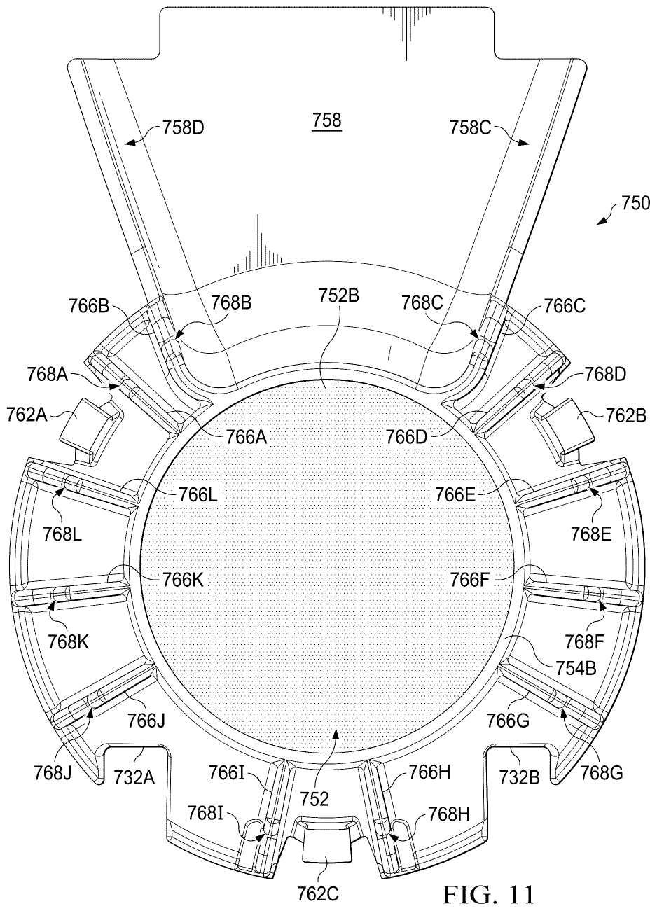

As described above, the cross-sectional area at the planar face 720A is larger than the second end cross-sectional area 752B (shown in FIG. 11) at the second end 754B of the stream engagement portion 754. Furthermore, the first end cross-sectional area 752A of the opening 752 at the first end 754A of the stream engagement portion 754 may be smaller than the cross-sectional area at the planar face 720A and larger than the second stream cross-sectional area 752B (shown in FIG. 11) at the second end 754B of the stream engagement portion 754. Generally, the cross-sectional area that the chlorinated water stream encounters tapers (e.g., decreases) from the first end cross-sectional area 752A to the second end cross-sectional area 752B. In some aspects, the cross-sectional area that the chlorinated water stream encounters continually tapers (e.g., decreases) from the first end cross-sectional area 752A to the second end cross-sectional area 752B. As described above, the tapering of the opening 752 increases the velocity of the chlorinated water stream, which aids in drawing gases that collect in the fluid cavity 726 into the chlorinated water stream. In some instances, the cross-sectional area that the chlorinated water stream encounters may taper at a constant rate. In other instances, the cross-sectional area that the chlorinated water stream encounters may taper at a changing rate. It is to be appreciated that the cross-sectional area that the chlorinated water stream encounters may taper differently than described herein.

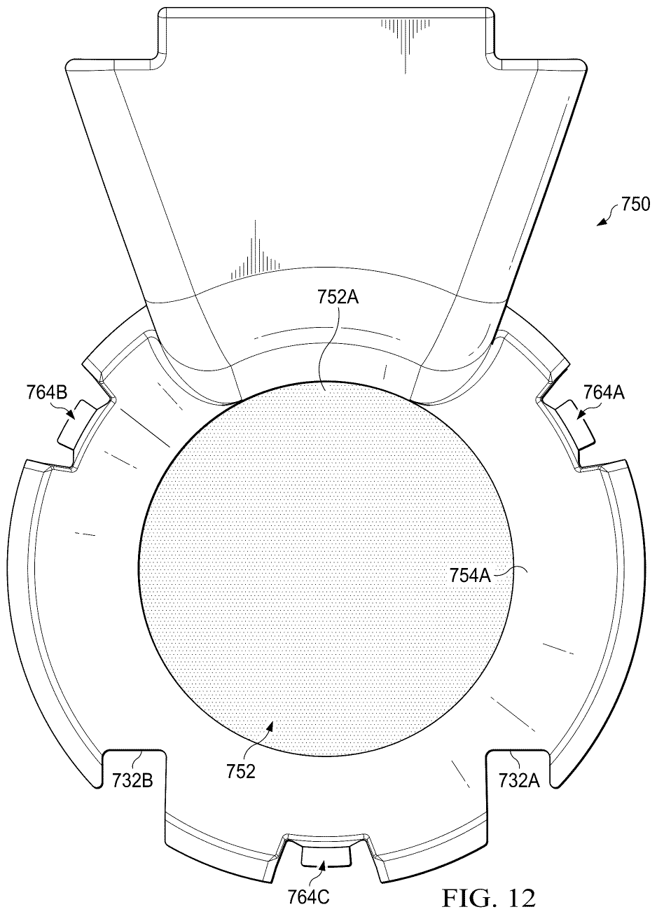

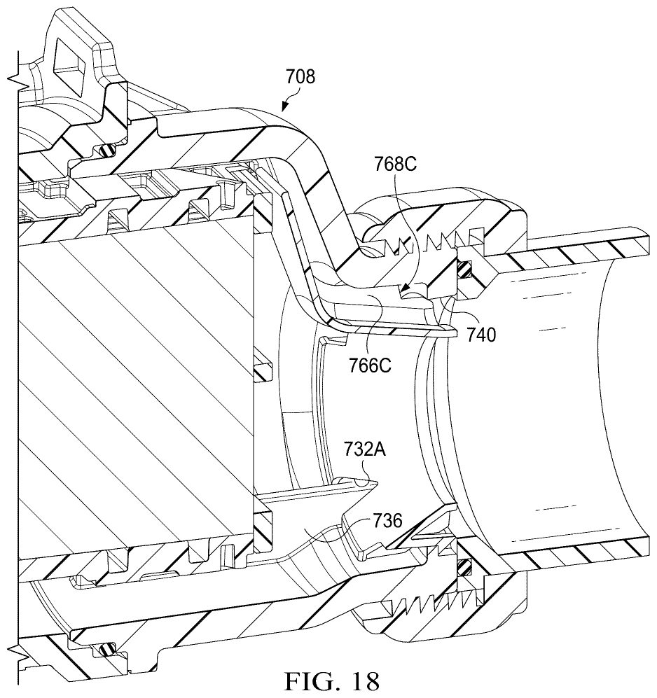

Referring now to FIG. 18 as well as FIGS. 11 and 12, the gas removal device 750 may include one or more cutouts 732 configured to shape the gas removal device 750 such that the gas removal device 750 may be coupled to, joined to, or formed with the housing 708. The one or more cutouts 732 may be substantially rectangular, although the one or more cutouts 732 may also be provided in other shapes and forms. In some aspects, the gas removal device 750 may include a first cutout 732A and a second cutout 732B of the one or more cutouts 732. The housing 708 may include one or more features including a first feature 736 and a second feature (not shown) that are designed to interface with the first cutout 732A and the second cutout 732B, respectively. The first cutout 732A may be configured and/or shaped to accept the first feature 736 while preventing fluid flow around the gas removal device 750, and especially around the stream engagement portion 754. In some aspects, the first cutout 732A may form a partial or completely water-tight seal with the first feature 736. Similarly, the second cutout 732B may be configured and/or shaped to accept the second feature while preventing fluid flow around the gas removal device 750, and especially around the stream engagement portion 754. In some aspects, the second cutout 732B may form a partial or completely water-tight seal with the second feature.

The housing 708 may include a lip 740 that may be arranged in parallel with the first stream exit cross-sectional area 752A. For example, the lip 740 may circumscribe the second end cross-sectional area 752B. The one or more of the engagement surfaces 768A-L may be configured to abut and/or engage the lip 740 and prevent movement of the gas removal device 750 in a positive direction along the X axis. As shown in FIG. 18, the third ridge 768C abuts and engages the lip 740.

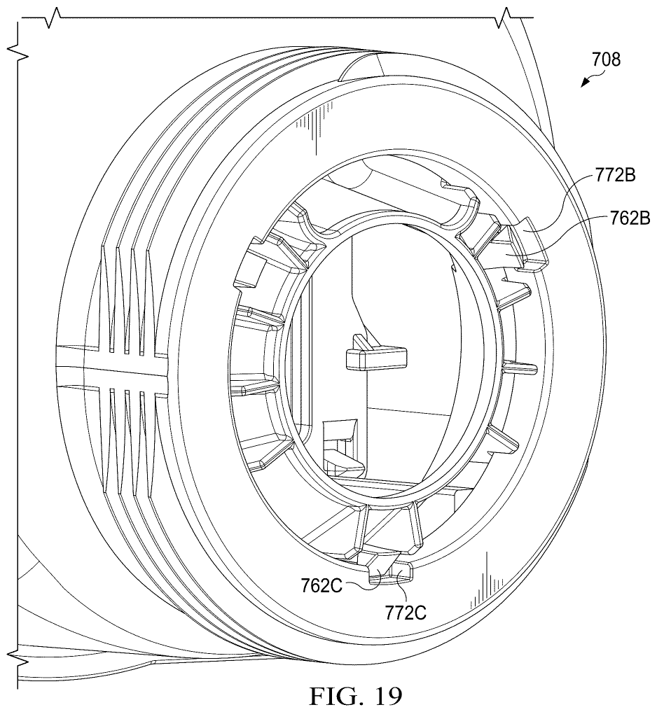

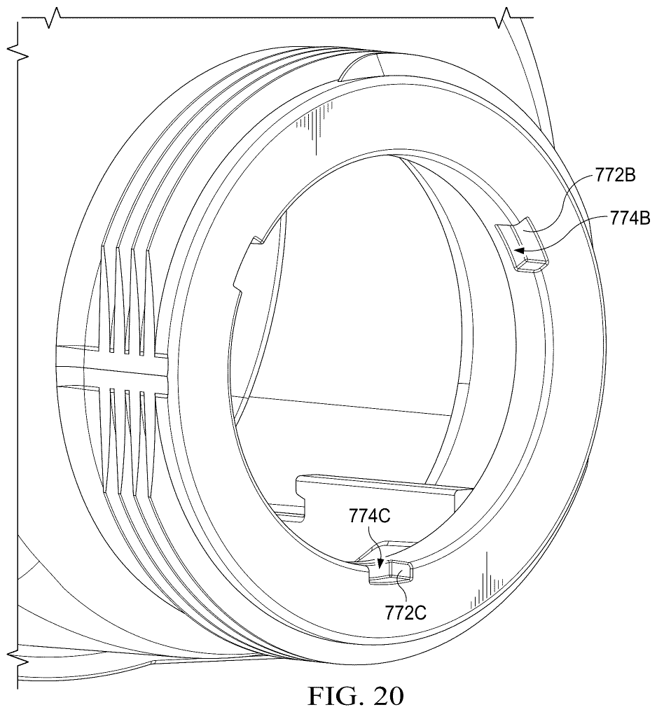

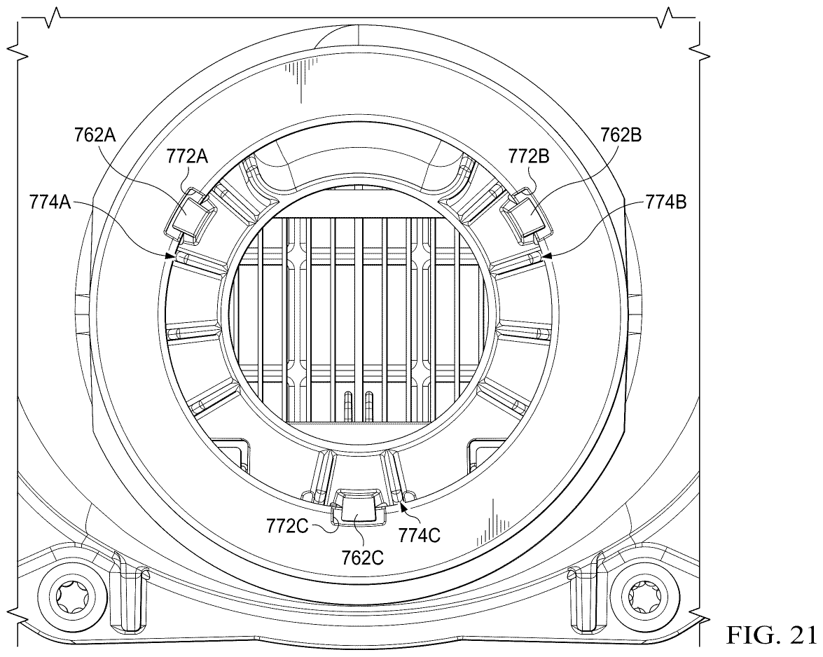

Referring now to FIGS. 19-21, the housing 708 may include one or more recesses 772. In some aspects, the housing 708 may include a first recess 772A, a second recess 772B, and a third recess 772C. The first recess 772A, the second recess 772B, and the third recess 772C may include a first tab lip 774A, a second tab lip 774B, and a third tab lip 774C, respectively. The plurality of tabs 762A-C may abut and/or engage the recesses 772A-C and prevent movement of the gas removal device 750 in a negative direction along the X-X axis (the X-X axis shown in FIG. 17). More specifically, the engagement surfaces 764A-C of the tabs 762A-C may engage the tab lips 774A-C to prevent movement of the gas removal device 750 in a negative direction along the X-X axis.

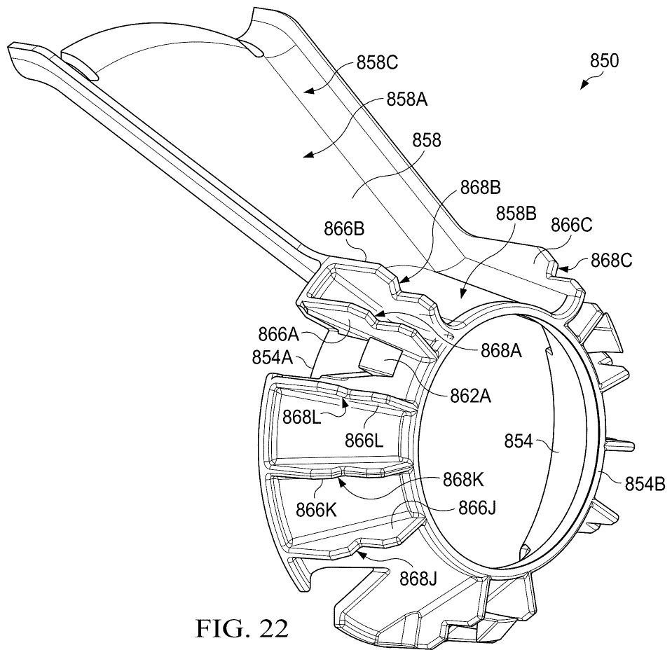

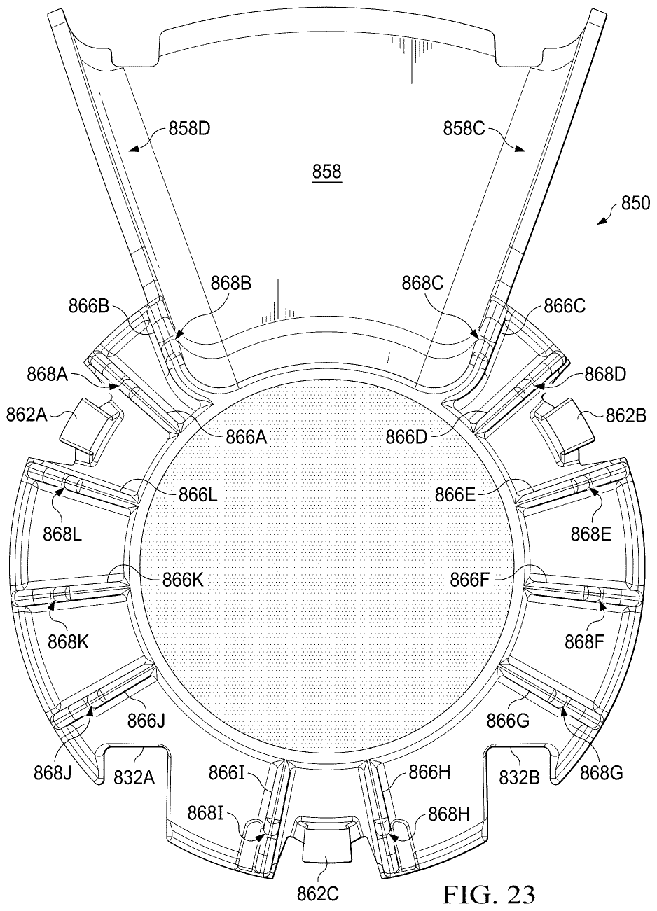

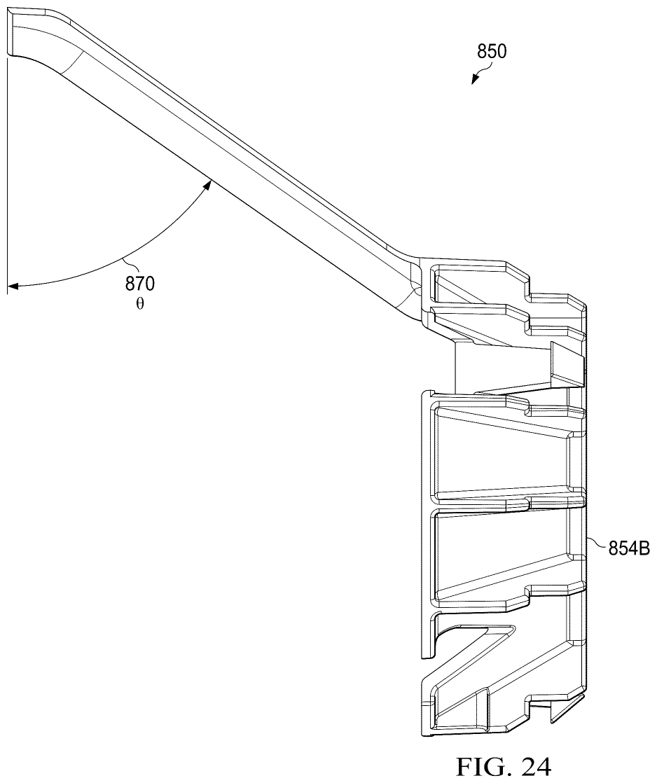

Referring now to FIGS. 22-25, a second gas removal device 850 is shown. The second gas removal device 850 may include a stream engagement portion 854 that may be substantially the same as the stream engagement portion 754 in FIG. 10. The stream engagement portion 854 may include a first end 854A and a second end 854B. The gas removal device 850 may include a plurality of cutouts 832A, 832B that may be substantially the same as the plurality of cutouts 732A, 732B in FIG. 11. The gas removal device 850 may include a plurality of ridges 866A-L that may be substantially the same as the plurality of ridges 766A-L in FIG. 11. The gas removal device 850 may include a plurality of engagement surfaces 868A-L that may be substantially the same as the plurality of engagement surfaces 768A-L in FIG. 11. The gas removal device 850 may also include one or more tabs 862A, 862B, and 862C and/or one or more ridges 866A-L, that may be substantially the same as the one or more tabs 762A, 762B, and 762C and/or one or more ridges 766A-L configured to retain the gas removal device 850 within the housing 808.

The second gas removal device 850 may include a gas engagement portion 858 that may include a first surface 858A, a second surface 858B, a third surface 858C, and a fourth surface 858D. Each of the first surface 858A, the second surface 858B, the third surface 858C, and the fourth surface 858D may be similar to the first surface 758A, the second surface 758B, the third surface 758C, and the fourth surface 758D in FIGS. 10 and 11. However, the gas engagement portion 858 may be angled away from the stream engagement portion 854 at an angle 870 that is different than the angle 770 in FIG. 11. In some aspects, a portion of the gas engagement portion 858 (e.g., the first surface 858A in FIG. 22) may form the angle 870 with a stream exit cross-sectional area at the second end 854B. The angle 870 may be about forty-five to seventy degrees. In some aspects, the angle 870 may be about fifty degrees.

The gas removal device 850 may be included in a salt chlorine generator 800. The salt chlorine generator 800 may include a housing 808, a chlorinator 812 including a part 824, and a fluid cavity 826 arranged between the chlorinator 812 and the housing 808. The housing 808, the chlorinator 812, the part 824, and the fluid cavity 826 may be similar to the housing 708, the chlorinator 712, the third carrier member 724, and the fluid cavity 726 in FIG. 17.

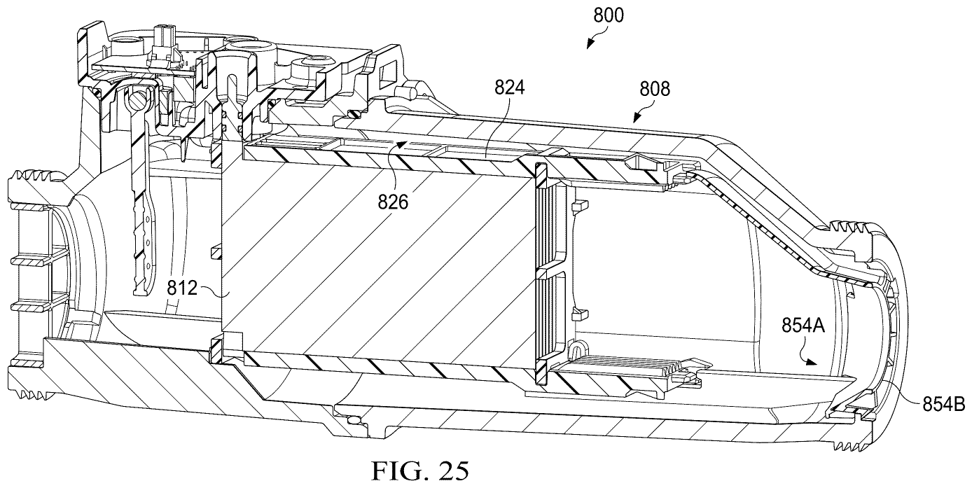

As best seen when comparing the salt chlorine generator 800 of FIG. 25 and the salt chlorine generator 700 of FIG. 17, the housing 808 can be elongated as compared to the housing 708 such that the distance between the first end 854A and the chlorinator 812 is greater than the distance between the first end 754A and the chlorinator 712. To accommodate the increased distance, dimensional characteristics of the gas engagement portion 858 may require changes as compared to the gas engagement portion 758. These dimensional characteristics may include changes to the angle 870 or an increase in length of the gas engagement portion 858 so as to successfully interface with the fluid cavity 826.

It will be appreciated by those skilled in the art that while the disclosure has been described above in connection with particular embodiments and examples, the disclosure is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the disclosure are set forth in the following claims.

What is claimed is:

1. A salt chlorine generator for chlorinating a fluid, the salt chlorine generator comprising:
a housing comprising:
an inlet opening designed to receive an incoming water flow;
an outlet opening designed to release an outgoing chlorinated water flow; and
a chlorinator mounted in a fluid cavity defined between the inlet opening and the outlet opening, the chlorinator designed to generate chlorine gas via an electrolytic process in the fluid cavity; and
a gas removal device positioned downstream from the chlorinator and proximate the outlet opening, the gas removal device comprising:
a gas engagement portion in fluid communication with the fluid cavity; and
a stream engagement portion in fluid communication with a chlorinated water stream, the stream engagement portion having a first upstream end and a second downstream end, the first upstream end defining a first opening with a first cross-sectional area, the second downstream end defining a second opening with a second cross-sectional area.

2. The salt chlorine generator of claim 1, wherein the second cross-sectional area is less than the first cross-sectional area such that a velocity of the outgoing chlorinated water flow increases from the first opening to the second opening to draw excess chlorine gas in the fluid cavity along the gas engagement portion and into the outgoing chlorinated water flow.

3. The salt chlorine generator of claim 1, wherein the second cross-sectional area is imparted with a first value that is about 50% to about 80% less than a second value of the first cross-sectional area.

4. The salt chlorine generator of claim 1, wherein the stream engagement portion tapers from the first opening to the second opening.

5. The salt chlorine generator of claim 1, wherein the stream engagement portion is provided in the form of a truncated hollow cone between the first opening and the second opening.

6. The salt chlorine generator of claim 1, wherein the stream engagement portion includes one or more ridges or one or more tabs that engage the housing to prevent movement of the gas removal device along an axis defined between the inlet opening and the outlet opening.

7. The salt chlorine generator of claim 6, wherein the housing includes a lip circumscribing the second cross-sectional area, and wherein the one or more ridges or tabs abut or engage the lip to prevent movement of the gas removal device along the axis defined between the inlet opening and the outlet opening.

8. The salt chlorine generator of claim 1, wherein the stream engagement portion includes one or more cutouts and the housing includes one or more features, and each cutout of the one or more cutouts is designed to accept a corresponding feature of the one or more features to form a seal between the gas removal device and the housing.

9. The salt chlorine generator of claim 1, wherein the gas engagement portion comprises a first surface projecting away from the first upstream end, and the first surface extends to a top surface of the chlorinator.

10. The salt chlorine generator of claim 9, wherein the first surface forms an angle of about fifteen to about sixty degrees with the first upstream end.

11. The salt chlorine generator of claim 1, wherein the gas removal device is provided in a single-piece construction.

12. The salt chlorine generator of claim 11, wherein the gas removal device is provided in a molded polymeric construction.

13. A gas removal device for a salt chlorine generator, comprising:
a gas engagement portion including a first surface; and
a stream engagement portion designed to receive a chlorinated water stream, the stream engagement portion having a first upstream end and a second downstream end, the first upstream end defining a first opening imparted with a first cross-sectional area, the second downstream end defining a second opening imparted with a second cross-sectional area,
wherein the first surface projects upward and away from the first upstream end,
wherein the second cross-sectional area is less than the first cross-sectional area.

14. The gas removal device of claim 13, wherein the gas engagement portion and the stream engagement portion are formed of a rigid polymer, the rigid polymer selected from the group comprising: acrylonitrile butadiene styrene (ABS), acrylonitrile styrene acrylate (ASA), polyamide (PA), polysulfone (PSF), polyethersulfone (PES), polyacrylonitrile (PAN), high-density and low-density polyethylene (PE), polypropylene (PP) and combinations thereof.

15. The gas removal device of claim 13, wherein the gas engagement portion further comprises a second surface, a third surface, and a fourth surface, wherein the third surface and the fourth surface are located on opposed sides of the first surface and wherein the second surface forms a portion of the stream engagement portion.

16. The gas removal device of claim 15, wherein one or both of the third surface and the fourth surface extend radially from the first surface.

17. The gas removal device of claim 13, wherein a stream engagement surface comprises a hollow body defined between the first upstream end and the second downstream end.

18. The gas removal device of claim 17, wherein the hollow body is tapered between the first upstream end and the second downstream end, wherein the first cross-sectional area is greater than the second cross-sectional area.

19. The gas removal device of claim 13, wherein the first cross-sectional area and the second cross-sectional area define a circular cross-section.

20. A salt chlorine generator comprising:
a housing having an inlet opening, an outlet opening and defining a fluid cavity therebetween;
a chlorinator mounted in the fluid cavity between the inlet opening and the outlet opening; and
a gas removal device mounted between the chlorinator and the outlet opening, the gas removal device comprising:
a gas engagement portion including a first surface; and
a stream engagement portion having a first upstream end and a second downstream end, the first upstream end defining a first opening with a first cross-sectional area, the second downstream end defining a second opening with a second cross-sectional area,
wherein the first surface projects upward and away from the first upstream end such that the first surface engages a top of the chlorinator, and
wherein the second cross-sectional area is less than the first cross-sectional area.
